(19) United States
(12) Patent Application Publication
(10) Pub. No.: US 2020/0281233 A1
(43) Pub. Date: Sep. 10, 2020

(54) SYSTEMS AND METHODS FOR APPYLING TREATMENTS FOR PRESERVATION OF PERISHABLE GOODS

(71) Applicant: RLMB Group, LLC, Honolulu, HI (US)

(72) Inventors: Randall Craig Bowden, Honolulu, HI (US); Robert W. Herdeman, Loveland, OH (US)

(21) Appl. No.: 16/811,862

(22) Filed: Mar. 6, 2020

Related U.S. Application Data
(60) Provisional application No. 62/815,258, filed on Mar. 7, 2019.

(51) Int. Cl. A23L 3/3589; A23B 4/30; A23B 7/158; B65B 55/18; A01N 3/00

(52) U.S. Cl. CPC A23L 3/3589; A23B 4/30; A23V 2002/00; B65B 55/18; A01N 3/00; A23B 7/158

(57) ABSTRACT

A method for treating a perishable product including determining a desired product treatment outcome selected from sanitation, protection, preservation, or enhancement of the perishable product; directly applying a substance to the surface of the perishable product after harvesting using a carrier; wet or dry washing the perishable product; and packaging the perishable product. A system for treating a perishable product with a substance treatment including one or more devices for directed substance application to a surface of the perishable products prior to final packaging of the perishable product using a carrier; and wherein the one or more devices is an electrostatically charging device or a nebulizer. Embodiments of the invention enhance the efficacy of sanitizers and other functional substances for increasing the quality, safety, and overall shelf life of perishable products through improved coating and distribution of the sanitizers and functional substances on the surface of perishable product.

### CROSS-REFERENCE TO RELATED APPLICATIONS

This application claims priority to U.S. Provisional Application No. 62/815,258 filed Mar. 7, 2019, the contents of which are hereby incorporated by reference in their entirety.

### TECHNICAL FIELD

The present invention generally relates to systems and methods for improved application of substance treatments for perishable goods. It further relates to improved methods and systems for prescribed, controlled, and efficient application of substance treatments on the surface of perishable products. More specifically, embodiments of the invention enhance the efficacy of sanitizers and other functional substances for increasing the quality, safety, and overall shelf life of perishable products through improved coating and distribution of the sanitizers and functional substances on the surface of perishable product.

### BACKGROUND

Perishable products generally have a short shelf life and are susceptible to damage or spoiling prior to reaching the consumer. Perishable products may include, for example, produce, plants, fresh or frozen foods, prepared foods, agricultural products, meats, cell cultures, tissues, and other live organisms. Perishable products may need to be transported from their growing area, and may be susceptible to pathogens during transit. Because of the additional transport time, the perishable product may have a very short shelf life once it reaches the consumer. In order to maximize the shelf life and to reduce the susceptibility to pathogens and spoilage, many perishable products are shipped via air, significantly adding to the cost. Additionally, some perishable products may be contaminated with bacteria or other pathogens from the source, and therefore require washing and/or sanitation before reaching the consumer. For many perishable products, the sanitation must be performed without thermally processing the perishable product. However, such steps are often insufficient or ineffective. Additionally, bacteria and fungus are brought into cooling rooms and processing equipment from the fields by contaminated products, further increasing the risk of contamination.

Particularly, vegetables including bagged salad and lettuce products have suffered from numerous outbreaks of E. coli and other contaminants, even so-called “triple washed” vegetables. Lettuce or greens harvested in the field may be rinsed with chlorinated water. The vegetables may undergo three washes, before being spun dried, and then weighed and bagged. However, the high amount of organic matter in the wash system can overwhelm the efficacy of the sanitizer. Ineffective sanitation (that is, the reduction and/or elimination of harmful microbial organisms or contaminated product) has led to sickness and even death in rare circumstances.

Cut flowers are stored in a cold room after harvesting, but are susceptible to mold prior to reaching the end consumer. As a result, flowers must be transported by air to diminish product loss, which increases costs significantly. Therefore, there is a need to treat flowers to prevent mold, while still maintaining the proper hydration of cut flowers that will increase the overall quality of the product and also allow for longer but less costly transport.

In the case of meats, the outside surface of meats may become contaminated with bacteria after harvesting, while the interior remains clean. Chemicals may be used to spray the outside surface of the meat to reduce the presence of bacteria. However, particularly in the case of ground or cut meat, the clean interior may become exposed to the contaminated exterior, which is then incorporated into the final product. There is a need to process meat in a clean manner using less chemicals, and to more effectively prevent or eliminate bacterial contamination.

The area of the fruit, for example tomatoes, that was attached to the stem (the pick scar) is a region that becomes especially susceptible to the establishment of spoilage organisms and potential contamination by human pathogens. Furthermore, fruit may become bruised or damaged which also creates areas especially susceptible to spoilage and microbial contamination. Other fruits, such as berries, are extremely sensitive to rapid mold growth, where any excess moisture or surface water present, even if a sanitizer is used, will result in reduced shelf life and accelerated spoilage.

Therefore, there is a need to treat perishable products with various substances to extend shelf life, to prevent, reduce and/or eliminate growth of spoilage and pathogenic (microbial) organisms on the perishable products, and to improve the overall quality of the perishable products. Further, there is a need to ensure that the substance treatment is applied to the perishable product uniformly, and sufficiently coats the surface of the perishable product. Still further, there is a need to apply the substance treatment to the perishable product in an open industrial environment or in an open packing line, in a manner that is safe to nearby workers and to the environment. Still further, there is a need to incorporate the above substance treatment to existing processing lines at various points of the process in a cost effective manner.

### SUMMARY

A method for treating a perishable product is provided, the method comprising: determining a desired product treatment outcome selected from sanitation, protection, preservation, or enhancement of the perishable product; directly applying a substance to the surface of the perishable product after harvesting using a carrier; wet or dry washing the perishable product; and packaging the perishable product.

A method for treating a perishable product is provided, the method comprising: determining a desired product treatment outcome selected from sanitation, protection, preservation, or enhancement of the product; directly applying a first substance to the surface of the perishable product after harvesting using a first carrier; and directly applying a second substance to the surface of the perishable product prior to final packaging of the perishable product using a second carrier; wherein the second substances enhances the efficacy of the first substance.

A system for treating a perishable product with a substance treatment is provided, the system comprising: one or more devices for directed substance application to a surface of the perishable products prior to final packaging of the perishable product using a carrier; and wherein the one or more devices is an electrostatically charging device or a nebulizer.

A system for treating a perishable product with a substance treatment is provided, the system comprising: one or more devices for directed substance application to a surface of the perishable product prior to final packaging of the perishable product using a carrier; a sensor for evaluating the surface of the perishable product; and a controller for controlling the directed substance application based on feedback from the sensor.

A method for treating a perishable product with a substance is provided, the method comprising: determining a desired product treatment outcome selected from sanitation, protection, preservation, or enhancement of the perishable product; evaluating the surface of the perishable product; and directly applying a substance to the surface of the perishable product after harvesting using a carrier based on the evaluated surface of the perishable product.

A method for treating a perishable product with a substance is provided, the method comprising: determining a desired product treatment outcome selected from sanitation, protection, preservation, or enhancement of the product; wet or dry washing the perishable product; directly applying a substance to the surface of the perishable product after harvesting using a carrier; and applying a durable coating to the surface of the treated perishable product.

A method for treating a perishable product with a substance is provided, the method comprising: determining a desired product treatment outcome selected from sanitation, protection, preservation, or enhancement of the perishable product; placing a perishable product in a tunnel, chamber, or a ventilated space; and directly applying a substance to the surface of the perishable product using a directed gas carrier in the tunnel, chamber, or ventilated space.

A method for treating a perishable product with a substance is provided, the method comprising: determining a desired product treatment outcome selected from sanitation, protection, preservation, or enhancement of the perishable product; evaluating a surface of the perishable product; determining a surface area of the perishable product; selecting the appropriate substance to treat the surface of the perishable product based on the surface evaluation; selecting the optimal volume of substance to be applied to the surface of the perishable product based on the substance and the surface area of the perishable product; selecting the optimal treatment time of the surface of the perishable product; determine the optimal carrier for applying the substance; determining the optimal distance from the surface for application of the substance; directly applying the optimal volume of the substance to the surface of the perishable product for the optimal treatment time at the optimal distance from the surface; measuring the amount of the substance that is present on the surface of the perishable product; reapplying the substance if the amount of the substance that is present on the surface of the perishable product is below a predetermined value; measuring the effect of the substance that is present on the surface of the perishable product; and reapplying the substance if the effect of the substance that is present on the surface of the perishable product is below a predetermined value.

A method for treating a perishable product with a substance is provided, the method comprising: determining a desired product treatment outcome selected from sanitation, protection, preservation, or enhancement of the perishable product; applying an electrostatic charge to the perishable product; applying an opposite electrostatic charge to the substance; and directly applying the electrostatically charged substance to a surface of the perishable product using a carrier.

A method of treating a perishable product with an electrostatically charged substance is provided, the method comprising: detecting an area on the surface of the perishable product prone to decay; applying an electrostatic charge to the perishable product; applying an opposite electrostatic charge to a substance; directly applying the substance to the area on the surface of the perishable product prone to decay using a carrier.

An apparatus for applying an electrostatically charged substance to a perishable product is provided, the apparatus comprising: an electrostatic mechanism for applying an electrostatic charge to the perishable product, a tunnel, a conveyor for receiving the perishable product and passing through the tunnel, and a second electrostatic spray mechanism for applying the electrostatically charged substance to the perishable product.

A punnet for cooling, treating, and packaging a perishable product, the punnet comprising: a first half having a perishable product receiving portion; and a second half fitting over the product receiving portion; wherein the second half removably engages with the first half thereby enclosing the product receiving portion, the punnet having a top flange where film is sealed to enclose the punnet when the second half is engaged with the first half.

A method for treating a perishable product with an electrostatic substance is provided, the method comprising: establishing a ground or a positive electrostatic charge to the perishable product; applying an opposite negative electrostatic charge to at least one substance; and spraying the perishable product with the at least one substance using a carrier. Alternatively, an electrostatically charged surface treatment can be applied that coats and adheres to the product and a second oppositely charged substance can be applied to the product.

An apparatus for applying an electrostatically charged substance to a perishable product is provided, the apparatus comprising: an electrostatic mechanism for applying an electrostatic charge to the perishable product or a means to ground the product, a tunnel, a conveyor for receiving the perishable product and passing through the tunnel, and a second electrostatic spray mechanism for applying the electrostatically charged substance to the perishable product.

A system to apply effective substances to perishable products at points in their general process and using improved methods for efficient application to increase their quality, safety, and overall shelf life is provided. The system includes determination of the substance treatment useful at the point in the product's general process, and then using the appropriate method and apparatus to efficiently obtain targeted and sufficient coverage of the product with the substance treatment.

Methods for treating a perishable product are provided, the methods comprising: creating substance treatments formulated for food safety, quality and/or shelf life improvement; inserting the substance treatments into advantageous steps of the general process for the product; using a carrier to enhance the spray, vaporized, atomized, or solid delivery of the substance treatment to the product; and applying opposite electrostatic charges to the substance treatment and perishable product to further enhance targeted and sufficient coverage of the product surface.

Apparatuses for applying the substance to a perishable product within the steps of its general process are provided, the apparatuses comprising: devices to deliver the substance treatment; devices to carry the substance treatment; devices such as an electrostatic spray bar for applying an electrostatic charge to the perishable product; devices to create an opposite electrostatic charge to the substance treatment; devices to determine a product is available for treatment; devices identifying a part of a product for substance treatment; devices to provide UV light or luminescence to detect products or parts for treatment or to determine sufficient treatment coverage, or to activate components of the substance treatment; controllers and/or programs directing the functions of the various apparatuses.

### BRIEF DESCRIPTION OF THE DRAWINGS

The features and advantages of the invention will be apparent from the following drawings wherein like reference numbers generally indicate identical, functionally similar, and/or structurally similar elements.

FIG. 1 is a schematic of electrostatic induction for substance treatment on a perishable product.

FIG. 2 is a perspective view a punnet with lidding film.

FIG. 3 is a perspective view of stackable and nestable punnets.

FIGS. 4A and 4B are a flow chart of punnet with lidding film processing options.

FIG. 5 is top view of an embodiment of a system for applying electrostatic substance treatment within a strawberry processing line.

FIG. 6 is a flow chart of meat processing incorporating substance treatments at various points within the process.

FIG. 7 is a flow chart of vegetable processing incorporating substance treatments at various points within the process.

FIG. 8 is a schematic of tomato plant process flow and substance treatment locations.

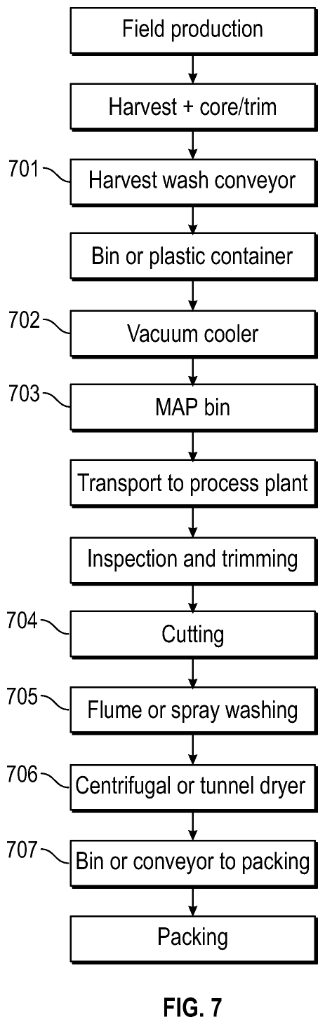

FIG. 9 is a flow chart of avocado processing incorporating substance treatments at various points within the process.

FIG. 10A is a schematic of flower chute cooling and conditioning tunnel.

FIG. 10B is an exemplary flower chute cooling and conditioning tunnel.

FIG. 11 is a flow chart of cannabis processing incorporating substance treatments at various points within the process.

FIG. 12 is a flow chart of hemp processing incorporating substance treatments at various points within the process.

FIG. 13 is an embodiment of a flow wrap machine incorporating substance treatment.

FIG. 14 is an embodiment of a form fill machine incorporating substance treatment.

### DETAILED DESCRIPTION

Embodiments of the invention are discussed in detail below. In describing embodiments, specific terminology is employed for the sake of clarity. A person skilled in the relevant art will recognize that other equivalent parts can be employed and other methods developed without departing from the spirit and scope of the invention.

Aspects of the invention relate to an overall systems approach for determining the best and appropriate substances and treatments for each perishable product. According to embodiments, the system to define process needs may include determining points in the process where substance treatments can be inserted, determining optimal methods for substance addition, providing other enhancements such as reduced dehydration and cross-contamination, and combinations thereof. Aspects of the invention include determining and integrating process management and controls. According to embodiments, process management and controls may include options for automatic or manual over-ride, integrating computer/PLU software-based processes, local and remote control, sensors used to direct treatment conditions and achieve target results (including vision technology, microorganism detection and measurement), and feedback loops, and use of artificial intelligence/machine learning. According to embodiments, process management and controls may include programmed cooling process with substance treatments, programmed refrigeration sanitation, programmed substance delivery, sensors to detect product for treatment, sensors to detect and measure level of sanitizer (application and residual levels), sensors to detect and measure microorganisms, vision technology to detect and direct treatments, recording process measurements for continuous system improvements and HACCP, and combinations thereof. Aspects of the invention include development and integration of programmed substance treatments. According to embodiments, programmed substance treatments may include pre-treatment, in-process treatment, sequenced treatment, final treatment, and combinations thereof. Aspects of the invention include assessing the product and process to determine a preferred substance delivery. According to embodiments, methods of preferred substance delivery may include dry delivery or washing (electrostatic charged and/or directed air/gas flow), wet delivery or washing (spray, electrostatic charged, nebulize/atomize), smart and robotic assisted spray, and substance delivery using directed air pressure or industrial gas, recirculating air, low volume liquid (water, ethanol, isopropyl alcohol and the like), water, ionized water, and ionized air, and combinations thereof. The dry washing/delivery may be the application of a dry or gaseous substance. The wet washingon/delivery may be the application of a wet substance. Aspects of the invention include developing and implementing effective and synergistic combinations of functional ingredients. According to embodiments, preferred combinations of functional ingredients may include anti-microbial sanitizing, surface adhesion, surface barrier film, humectant, preservative, organoleptic, health, plant nutrition, surfactants, buffering agents, emulsifiers, direct product application of electrostatic+UV light treatments, MAP N₂+ ozone, and combinations thereof. According to embodiments, substances to reduce microorganisms may include ozone, sanitizers, essential oils, or combinations thereof.

Embodiments of the invention relate to applying a substance treatment to a perishable product at various points during processing from harvest to final packaging and transport. According to embodiments, the directed application is by electrostatic spray. According to embodiments, the directed application is by a nebulizer. According to embodiments, the directed application is by fogging. According to embodiments, the directed application is electrical energy, electrical pulses, ultra sound, UV light, electromagnetic treatment and the like. According to embodiments, the directed application achieves sufficient product coverage to efficiently achieve the desired result with minimal overspray. For example, the substance treatment may be an essence compound that is very expensive, but may be efficiently applied using embodiments of this invention, thereby saving money.

According to embodiments, the substance treatment may be applied using a wet or dry delivery system. According to embodiments, the substance treatment may be delivered by electrostatic spray, nebulized, fogged, vaporized, atomized, or directed air application. According to embodiments, the substance may comprise industrial gas, liquid, or powder ingredients. According to embodiments, the substance treatment may be delivered to the surface of a product between harvesting, production, and final packing. The substance treatment according to the present invention may prevent or delay the onset of quality defects by reducing or eliminating the damaging organisms on the surface of the product. The substance treatment according to the present invention can be applied in conjunction with the harvest, or during processing. According to embodiments, substance treatment can be applied in open, partially open, or closed environments but do not require an air tight or hermetically sealed enclosure. Using the system does not need or require a modified atmosphere or controlled atmosphere enclosure, and can be applied completely open to the atmosphere or within a partially enclosed space still open to the atmosphere, such as a spray chamber or tunnel, to contain the spray or substance treatment and achieve the intended outcome safely and effectively. A modified atmosphere is an airtight sealed enclosure around the perishable product to allow for injection and maintenance of industrial gases. Advantageously, the present invention can allow for less packaging and waste as compared to substance treatment within the sealed enclosure of a modified atmosphere, and allows for substance treatment to be added to existing commercial operations. The substance treatment according to the present invention can be combined with a modified atmosphere for additional benefits.

Embodiments of the invention relate to applying a substance treatment to a perishable product to facilitate the precise and even application of the substance treatment. According to embodiments, a predetermined amount of the substance may be applied to the surface to substantially contact or coat the surface, where some treatments will cover a predetermined amount of the targeted surface, some substance treatments will leave no residual level of surface coverage, and others may need one or more passes to achieve the levels required. The substance may be a sanitizer, protective coating, preservative, flavor and/or aroma enhancer, color, nutritional additive, or any other substance that may improve the shelf life, quality, safety, value, appearance, or aroma of the perishable product. According to embodiments, the substance treatment may be a surfactant or other compound to enhance the functional efficacy or contact of other treatment ingredients. According to embodiments, the substance treatment may be an essence, extract, or essential oil. According to embodiments, the substance treatment according to the present invention may provide sanitizing, anti-fungal, or flavoring directly to the product's surface. According to embodiments, the substance treatment may be a liquid surface coating using ionized water or a directed air or industrial gas surface coating. According to embodiments, the substance may include O₃, organic compounds, humectants, buffering agents, and mineral salts.

According to embodiments, the substance may be applied to the perishable product using a carrier, which may be a gas or a liquid, depending on whether the substance is applied as a dry treatment or a wet treatment. According to embodiments, the substance may comprise a functional diluent or solvent, including but not limited to water, ionized water, chlorinated water, ozonated water, ethanol, isopropyl alcohol, and the like. A functional diluent is one that also provides efficacy to control or reduce bacterial contamination, and/or makes the delivery of the substance to the product more efficient and effective and/or enhances the usefulness of the substance to achieve the intended and desired outcome. According to embodiments, the substance may comprise a sanitizer, including but not limited to chlorine dioxide, hydrogen peroxide, peracetic acid, ozone, and other gaseous forms of sanitizers and the like. According to embodiments, the substance treatment may be an oxidizing agent or a reducing agent. According to embodiments, the substance treatment may comprise an essential oil, including but not limited to lemon oil, orange oil, grapefruit oil, rosemary oil, sunflower oil, other fruit-derived oils, tea tree oil, cinnamon oil, rose oil, eucalyptus oil and the like. According to embodiments, the substance may comprise a surfactant including but not limited to potassium oleate, sodium dodecyl sulfate (SDS) and the like. According to embodiments, the substance may comprise a humectant including but not limited to sorbitol, glycerin, glycerol and the like. According to embodiments, the substance may include buffering agents and/or mineral salts including but not limited to ascorbic acid, citric acid, sodium bicarbonate, calcium phosphate and the like. According to embodiments, the substance may include aroma and flavor compounds including but not limited to ethyl acetate, esters, linear terpenes, cyclic terpenes, alcohols, aldehydes, esters, ketones, lactones, thiols and the like. According to embodiments, the substance may be an anti-browning substance, an ethylene scavenger including but not limited to potassium permanganate, a ripening agent (ethylene or ethylene generating compound), a nutritional substance, a probiotic, coloring, nano particles, phages, enzymes, or a sugar substance.

According to embodiments, the substance may remove or deactivate harmful compounds on the perishable product. According to embodiments, the substance may be electrical energy, electrical pulses, ultra sound, UV light, or other electromagnetic treatment. The directed energy may activate substances already applied to the surface of the product and/or may be a substance treatment in and of themselves by impacting the electrons and subsequently damaging or destroying microorganisms or converting pesticides or other substances or undesirable chemical compounds into harmless compounds. According to embodiments, the substance treatment may be directly ionizing surface moisture, water, or a prescribed and specific liquid compound the surface of the product. According to embodiments, the electrical current may be turned on and off as needed to provide an efficient and effective sanitation treatment.

The substance may include, for example, a sanitizing substance, a flavoring substance, a preservative substance, a food additive substance, a coating substance, a sealing substance, an essence and/or essential oil substance, a mineral substance, a vitamin substance, a biological substance, a hydrocolloid, and other substances. The sanitizer substance may be in the form of a gas, a liquid, atomized, or a vaporized liquid, and may include, for example, ozone, nitrous oxide, inert gases, chlorine in all its forms, hydrogen peroxide, peracetic acid, nitrite and nitrate compounds, iodine, benzoates, propionates, nisin, sulfates, and sorbates or any other suitable gas or gaseous sanitizer. The flavoring substance may include any flavoring that is suitable for application to and/or infusion in the products.

Additionally, the substance may include one or more of coloring substances, food grade acid substances, mineral salt and/or mineral salt solutions, nutritional additives, sweeteners, flavor enhancers, and the like. The extracts, essence and/or essential oil substance may be in the form of a gas, a liquid, or a vaporized liquid, and may include, for example, essential oils from fruits (e.g., strawberries, blueberries, pomegranates, grapes, lemons, grapefruits, oranges, other citrus, cherries, and the like), vegetables, flowers, and other perishable food products, including, for example but not limited to, mint, clove, green tea, rose hips, hibiscus, ginseng, cacao. According to embodiments, the substance may be rose oil, rose essence, or a fruit essence. An essence substance may possess in high degree the predominant qualities of a natural product (as a plant or drug) from which it is extracted (as, for example, by steam distillation or infusion). An essential oil substance may include a concentrated hydrophobic liquid containing volatile aroma compounds of the plant or product from which it was extracted. An essence and/or essential oil substance may be collected from distillate from processing fruit products and may have antimicrobial and/or anti-fungal properties. An exemplary essential oil may include thyme oil (thymol; 2-isopropyl-5-methylphenol, IPMP). The mineral substance may be in the form of a gas, a powder, a liquid, a fluidized compound, a vaporized liquid. The vitamin substance may be in the form of a gas, a powder, a liquid, a fluidized compound, or a vaporized liquid, and may include, for example but not limited to, thiamine hydrochloride, riboflavin (Vitamin B2), niacin, niacinamide, folate or folic acid, beta carotene, potassium iodide, iron or ferrous sulfate, alpha tocopherols, ascorbic acid, Vitamin D, amino acids (L-tryptophan, L-lysine, L-leucine, L-methionine) or any other suitable gas, powder, liquid, or vaporized liquid vitamin substance. The biological substance may be in the form of a gas, powder, micro or nano particle, a fluidized compound, a liquid, or a vaporized liquid, and may include, for example, probiotics such as Lactobacillus and Bifidobacterium or any other suitable gas, liquid, or vaporized liquid biological substance. Probiotics may include live microorganisms that may confer a health benefit on the host when consumed such as, for example, naturally occurring beneficial or “friendly organisms” which are biologically active against pathogenic and spoilage organisms. In accordance with an embodiment, the biological substance can be added to the sealed enclosure, for example, after a sanitation cycle/sequence has occurred or as part of a standalone treatment and may provide benefits by, for example, crowding out harmful organisms on the surface of the perishables and/or providing antimicrobial and anti-fungal properties. The hydrocolloid substance may include, for example but not limited to, alginate, pectin, carrageenan, gelatin, gellan, and agar. The substance may include, for example but not limited to, one or more of calcium sulfate, ammonium phosphate, Ascorbic acid, citric acid, sodium benzoate, calcium propionate, sodium erythorbate, sodium nitrite, calcium sorbate, potassium sorbate, BHA, BHT, EDTA, tocopherols (Vitamin E), Citrus Red No. 2, annatto extract, beta-carotene, grape skin extract, cochineal extract or carmine, paprika oleoresin, caramel color, fruit and vegetable juices, saffron, supplements, and phages.

According to embodiments, the substance may be a pigment. According to embodiments, the substance may be a photosensitizer. According to embodiments, the substance may be a light sensitive compound.

According to embodiments, the dwell time, that is, the amount of time the substance remains active on the perishable product, may be manipulated to obtain the desired outcome. According to embodiments, the appropriate dwell time may be seconds to hours to days. According to embodiments, the dwell time is adjusted to enable the substance containing sanitizer to properly kill or render inactive the microorganisms present. According to embodiments, a defined dwell time of a substance may be selected based upon its purpose and characteristics or properties where the substance could have a short or long target dwell time. For example, the use of a strong sanitizer solution with a kill on contact or in only seconds requires a short dwell time, whereas a sanitizer such as a light solution of acid would necessitate a longer required contact time to have an effect on microorganisms. Other substances such as mineral salts, essential oils, or essences would remain active on the product to final consumption or use. According to embodiments, it is desirable to use a very strong sanitizer to obtain the best sanitizing effect. According to embodiments, the sanitizer may be peroxyacetic acid, acetic acid, ozone, hydrogen peroxide, or essential oils. However, using a very strong sanitizer would likely have a damaging effect on the perishable product. According to embodiments, a strong sanitizer is used to treat the perishable product, followed by an additional treatment after the appropriate dwell time of the sanitizer to deactivate, dilute, diminish, or remove the sanitizer to prevent damage to the product. According to embodiments, the dwell time for peroxyacetic acid and acetic acid may be one minute to several hours. According to embodiments, the dwell time for ozone and hydrogen peroxide may be seconds to minutes. According to embodiments, the dwell time for essential oils may be minutes to days.

According to embodiments, the substance treatment may remove, deactivate, or otherwise neutralize a substance that is on the perishable product. For example, some perishable products may be contaminated with chemical compounds such as herbicides and/or pesticides and therefore require washing and/or treatment to convert those chemicals into harmless compounds that can simply rinse away and be deactivated. For example, pesticides such as carbamate and organophosphate undergo a chemical reaction on contact with high pH ionized alkaline water called alkaline hydrolysis, which breaks down the active ingredient in those pesticides into harmless compounds, which are easily washed away. According to embodiments, the substance treatment may be directed electrical energy, electrical pulses, ultra sound, UV light, electromagnetic treatments, whereby they activate substances already applied to the surface of the product, and/or are used as standalone substance treatments by impacting the electrons and subsequently damage or destroy microorganisms or convert pesticides or other substances or undesirable chemical compounds into harmless compounds.

According to embodiments, one or more devices deliver directed (assisted) or targeted treatment of one or more substances to a product between the time it is harvested and the time it is packaged. According to embodiments, a method is provided comprising determining, selecting and programming a desired product treatment outcome in terms of sanitation, protection, preservation or enhancement of the perishable product.

According to embodiments, the directed substance treatment may be in addition to a washing or sanitization step. According to embodiments, the washing or sanitization may be wet or dry. According to embodiments, the one or more devices may be electrostatically charging devices, nebulizers, directed sprayer of ionized (acidic or alkaline) water, ozonated water, or electrolyzed water, directed sprayer of ionized air, or any combination thereof. According to embodiments, the devices may continuously manage the process by feedback loop to ensure sufficient treatment without the negative effects of overspray or over use of materials (the negative effects including damage to the product, increased cost, and the environmental impact of increase in waste, among others). According to embodiments, the one or more devices are completely automated.

According to embodiments, the substance treatment may be applied in an open air environment, meaning that the treatment does not need to occur in an airtight or nearly airtight sealed enclosure. According to embodiments, the substance treatment may be in a contained or semi-enclosed space such as a cabinet or a tunnel. According to embodiments, the perishable product may be on a conveyor line and pass through a tunnel where substance treatment occurs. According to embodiments, the substance treatment may occur within a centrifugal or tunnel dryer. According to embodiments, the substance treatment may occur within a forced air cooling unit. According to embodiments, the substance treatment may occur outdoors. According to embodiments, the substance treatment may occur in a fog tent. According to embodiments, the substance treatment may be a portable system. According to embodiments, the substance treatment may occur in a cold room or refrigerator. According to embodiments, the substance treatment may occur in a greenhouse. According to embodiments, the substance treatment may occur in an open air environment prior to packaging and/or final packaging of the product.

According to embodiments, the treatment device may apply an atomized substance to the perishable product. The atomization may be controlled which allows for the desired application of the anticipated wide range of substances, with different viscosity and/or fluid flow rates by managing and controlling the atomization energy. According to embodiments, atomization may be by centrifugation, in which the fluid is introduced to the center of a spinning disk and the fluid breaks up into fine droplets as it flows off the disk's edge. According to embodiments, the atomization may be ultrasonic atomization, in which fluid passes over a vibrating device that causes a breaking up of the fluid into droplets. According to embodiments, the atomization may be electrostatic, in which fluid is exposed to an electric field that tears the droplets from the atomizer and propels them towards the work surface. According to embodiments, the atomization may be pressure atomization, in which fluid is forced through an orifice at high speed, and friction disrupts the fluid stream and breaks it up into droplets. According to embodiments, the atomization may be air atomization which employs a high pressure air stream that surrounds fluid under low pressure and friction disrupts the fluid stream and breaks it into droplets.

According to embodiments, the treatment device may be a directed sprayer. According to embodiments, the spray system can include numerous types of manual and automatic spray guns and devices. According to embodiments, the spray may be an air spray. According to embodiments, the spray may be air-assisted, which combines hydraulic atomization of airless with air for fine atomization. According to embodiments, the spray may be airless, in which directs fluid under high pressure through a controlled orifice to accomplish airless atomization. According to embodiments, the spray may be electrostatic, in which material is electrostatically charged and is attracted to the grounded (neutral) or positively charged object/product to form an even coating. According to embodiments, the spray may be a compact paint gun, lightweight electrostatic gun, high-pressure air-assisted electrostatic spray gun, low pressure air-assisted spray gun, manual electrostatic paint gun, automatic electrostatic spray gun, direct charging, tribo charging, or post-atomization charging. According to embodiments, the distance of the directed sprayer from the perishable product and the volume of substance use may be adjusted to optimize coverage of the perishable product. According to embodiments, the directed sprayer may be timed to turn on and off to coat the perishable product with minimal waste.

According to embodiments, the treatment device may be a nebulizer. According to embodiments, the substance may be applied by a nebulizer to vaporize the substance and enable surface contact and coverage, or adsorption or infusion of the substance. According to embodiments, the nebulized substance may become part of the air or gaseous environment, evaporated or vaporized to achieve a specified amount or concentration added to the carrier gas or air. According to embodiments, the treatment device may be a fogger. According to embodiments, the temperature of the substance, the temperature of the product, and the treatment environment may be manipulated with any of the treatment devices discussed herein in order to obtain the optimal application and coverage of the substance on the perishable product.

According to embodiments, the system and methods according to the invention treat perishable products with substances in unique ways and locations not previously conceived. Current production methods do not take advantage of their natural process to conceive of ways to sanitize or enhance the quality of the product. According to embodiments, substance treatment may be added to a forced air cooling chamber using ozone and essential oils during prolonged cooling steps. According to embodiments, substance treatment may be added to a cooling tunnel, cooling room, cooling chamber, tented, tarped, or partially contained, curtained, or contained environment with some capacity for products to enter and exit via an opening or unsealed entrance door or curtained opening and/or exit. A cooling tunnel passes pressurized or directed air flow directly across or through a perishable product in a specialized room or tunnel. A cooling tunnel differs from a cold holding room or refrigerated room, in which cold air is not being directed through or around the product. Rather, in a cold holding room or refrigerator the perishable product is passively allowed to acclimate to the inside air temperature. According to embodiments, a gaseous sanitizing step is applied in a cooling tunnel. According to embodiments, the sanitizer is carried using directed or pressurized air. According to embodiments, the gaseous sanitizing step includes ozone. According to embodiments, the gaseous sanitizer is recycled back into the cooling tunnel. According to embodiments, the substance may be applied during cooling of the perishable product in a cooling tunnel, a cooling room or chamber, or a ventilated space where the substance can be recirculated or directed across the surface of the product. According to embodiments, the method includes assessing whether it is desirable for the perishable product to be cooled. According to embodiments, the treatment may occur in a room, chamber, tented, tunnel, tarped, or partially contained, curtained, or contained environment with some capacity for products to enter and exit via an opening or unsealed entrance door or curtained opening and/or exit in which the directed air is not cooled. According to embodiments, the directed air is of ambient temperature. According to embodiments, the directed gas carrier may be forced across the surface of the perishable product. According to embodiments, using the forced air or pressure cooling or pressurized ripening rooms are also optional locations to apply the substance treatments efficiently either while cooling or ripening is in progress, or before or after the cooling or ripening process. According to embodiments, directed air from a pressurized gas gun or cannon may be used as the carrier for substance treatments that can coat or penetrate the surface of the perishable product. According to embodiments, the treatment includes a sanitizer, surfactant, and buffering agent. According to embodiments, the consumption of ozone and/or the presence of microorganisms is monitored.

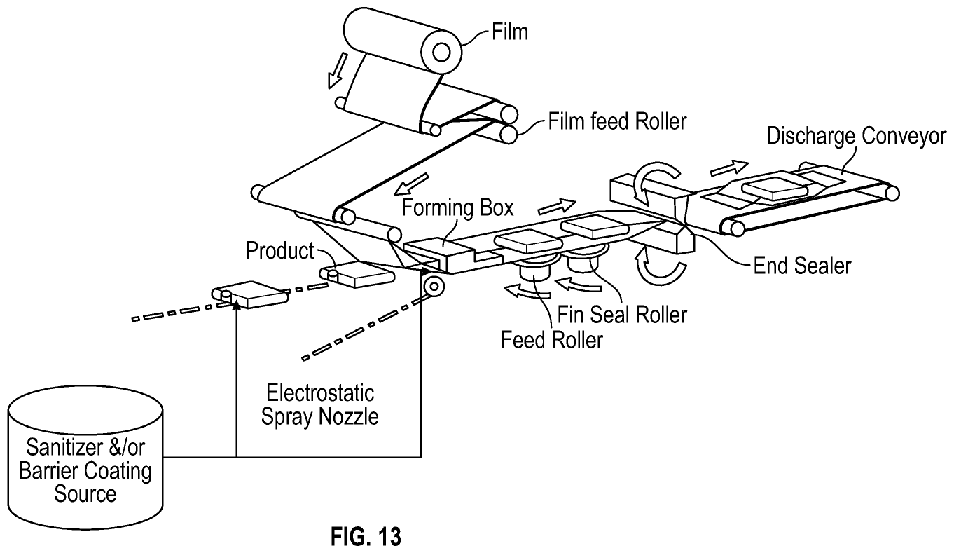

According to embodiments, the perishable product may be treated inside of a film forming mechanism or machine or just prior or simultaneous to when the package is formed around the product, as shown in FIG. 13. The controlled final treatment of FIG. 13 may be wet or dry substance treatments, directed at product on feed conveyor (surface treatment), directed at product inside film forming box (surface and/or atmosphere treatment), or combinations thereof.

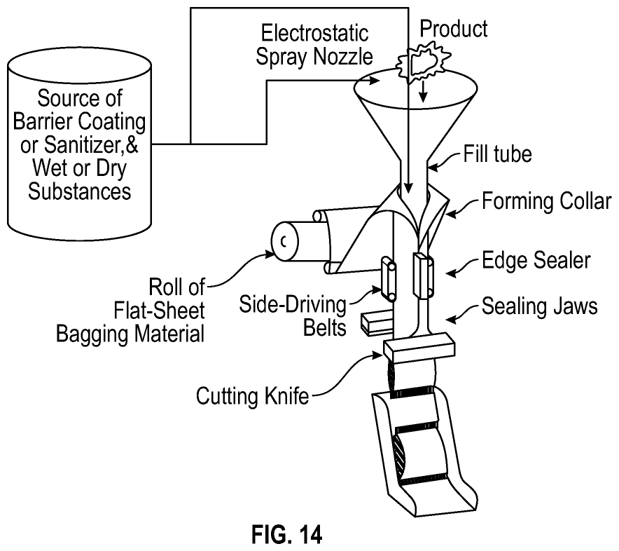

According to embodiments, the perishable product may be treated inside of a film forming tube which is a bag forming and filling machine prior to or simultaneous to when the package is formed around the product, as shown in FIG. 14. The controlled final treatment of FIG. 14 may be wet or dry substance treatments, directed at product falling into the feed tube (surface treatment), directed at product inside film forming tube (surface and/or atmosphere treatment), or combinations thereof. According to embodiments, the perishable product is treated before final packaging of the perishable product. According to embodiments, final packaging may include all government approved food contact packaging materials and consumer packaging: before filling, during filling of the product into the package, in conjunction with, or simultaneous to the final packaging of the product. Types of consumer product packaging include but are not limited to: a tray, punnet, clamshell, pouch, cup, bowl, bag, flow wrapped package, box, these materials could include any standard packaging material including plastic, fiber based (pulp, cardboard, paper chipboard), or glass.

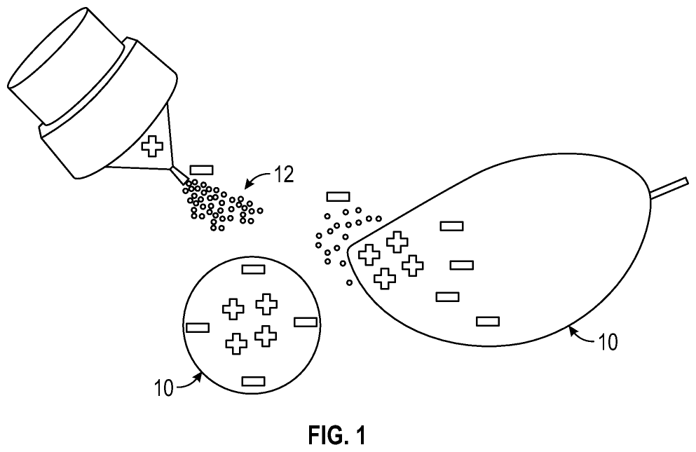

According to embodiments, the substance treatment may be directed to the perishable product using an electrostatic spray to achieve enhanced directed spot and/or surface coverage. According to embodiments, the substance may be electrostatically charged before application to the perishable product. Prior to substance treatment, the perishable product may also be electrostatically charged, or grounded, or a state that will facilitate an electrostatic charge. As shown in FIG. 1, the perishable product 10 and the substance 12 may be oppositely charged to increase the attraction between the perishable product and the substance (e.g., by electrostatic induction). The electrostatically charged substance may be applied to the perishable product using directional assisted air or industrial gas flow and/or a pressure gradient allowing charged treatments to directly contact and benefit the perishable product. The electrostatic charge may be applied by a mechanism, including a nozzle or spray bar. The electrostatically charged substance treatment thereby increases the efficacy and efficiency of applying the substance to the perishable product.

According to embodiments, the electrostatically charged substances can be applied to the entire surface or to parts of products as coatings. The application of the electrostatically charged substance is enhanced by electrostatically charging the perishable product with the opposite charge as the substance. The oppositely charged product and substance are attracted to each other, which facilitates in the coating the product with the substance, and that the substance remains in contact with the product. Charging the product also allows for accurate and precise application of the substance. The substance treatments may be applied in large or very small amounts, designed to interact or combine on the product surface and/or to provide a specific benefit/value to the product(s). For example, a product may have its surface charged or pretreated to efficiently accept an oppositely charged substance such as a very specific and defined quantity/treatment level of a highly active sanitizer.

According to embodiments, electrostatic treatment and substance application of perishable products may involve simultaneous or sequenced applications. For example, products may be quickly and efficiently treated on a packing line or at a fill station as the products pass by. According to embodiments, the electrostatically charged substance may be applied from above, below and/or the sides of the product as the product moves through the packing line. According to embodiments, charged particles and substances treatments may utilize a directed gas, liquid, volatilized liquid, atomized liquid, air flow, or air pressure as a carrier to aid in their application, and may appear as a spray bar, gas nozzle, and/or electrostatic charging bar above, below, and/or on the sides of the product as it passes by the treatment area. The substance treatment(s) may be applied horizontally or vertically, prior to packaging or in combination with the packaging process. According to embodiments, the product packaging may also include modified atmosphere treatments that work in combination or independently of the electrostatically charged product(s), and/or multiple electrostatically charged particles, compounds, and/or substance treatments.

According to embodiments, the product is positively charged. According to embodiments, the product is negatively charged. According to embodiments the product may not be electrostatically charged. According to embodiments, the product and the substance are oppositely charged. According to embodiments, the substance is positively or negatively charged, while the product is not electrostatically charged. According to embodiments, the first substance is positively or negatively charged, and an oppositely charged second substance is layered over the first substance. According to embodiments, the product is charged, and the substances are oppositely charged. According to embodiments, several substances are used to treat the product. According to embodiments, several substances are premixed and then applied to the product. According to embodiments, more than one substance is used to treat the product, each at different points of the processing line. According to embodiments, the more than one substance may have the same or different charges.

According to embodiments, the substance treatment may be part of a multistep substance treatment. According to embodiments, the multistep substance treatment may achieve a synergistic effect such that the overall result is improved compared to the individual steps alone. According to embodiments, the multistep substance treatment may comprise pretreatment, treatment, and post-treatment steps. According to embodiments, the pretreatment, treatment, and post-treatment may use the same or different combinations of ingredients. According to embodiments, the multistep substance treatment enables effective reduction/killing/rendering inactive microorganisms while also providing other functional benefits such as humectants, mineral salts, and aroma to enhance quality, shelf life and physical characteristics of the product. According to embodiments, a pretreatment may prep the surface of the product, target the organism and/or biofilm in one treatment making subsequent treatments more effective. According to embodiments, the one or more sanitizer pretreatments may be followed by a substance to enhance the physical characteristics of the now cleaner product surface. According to embodiments, a subsequent or post-treatment may coat the surface to prevent further growth of microorganisms on the now sanitizer treated surface. According to embodiments, sequencing the treatments provide synergy compared to combining or mixing the substances into one treatment. According to embodiments, the pretreatment substance may be directed/targeted to and attack a microorganism or break down biofilm on the surface of the perishable product to reduce microorganism levels. According to an embodiment, the perishable product may first be treated with hydrogen peroxide followed by a chlorinated water wash. According to an embodiment, the perishable product may first be treated with a surfactant followed by a wash step including a sanitizer. According to an embodiment, the perishable product is treated with a sanitizer followed by one or more steps to apply a coating to seal the product surface. According to embodiments, the coating may be a durable coating. According to embodiments, the coating may be non-permeable, permeable or be semipermeable coatings using designed patterns of application, etching, chemical or mechanical treatment, material selection, thickness and composition of waxes, foams, minerals, gels, gas infused substances, and other means to create intentional gaps, or desired moisture or gas transmission characteristics in the coating. According to embodiments, the durable coating may include cellulose, chitosan, alginate, potato starch, carboxymethylcellulose, aloe vera gel, calcium caseinate, whey protein, gelatin, soy protein, butyl acetate, plant based waxes, or any common commercially available food grade waxes and coatings, and the like.

According to embodiments, combinations of sanitizer substances may be used within a treatment, within a multistep treatment, and/or within a sequence of treatments to kill or render inactive microorganisms. According to embodiments, sanitizers may include ozone, ionized water (acidic or alkaline), chlorine dioxide, peroxygen bleach, peracetic acid, essential oils and terpenes, ethanol, mineral salts, phages, and the like.

According to embodiments, a substance may be applied to the perishable product in an inactive or less active form, and then subsequently activated by applying a second substance, a light wave, a sound wave, pH, luminescence, enzyme, water, electricity/electrical charge, or other artificial means. According to embodiments, the activation may create a new substance that has sanitization or other properties to enhance, preserve or protect the product. For example, substances such as peroxygen bleach may have properties that make them incompatible to be pre-mixed with other components or they are unstable in the completed form, therefore, forming them “in-situ” is a viable method of use. According to an embodiment, two substances may be independently applied to the surface that react to create a sanitizer that would have efficacy. According to an embodiment, a substance may be applied to the surface and would become a sanitizer under a change in pH or presence of luminescence, etc.

According to embodiments, sensor technologies including visual, light, sound, temperature, magnetic, and chemical sensing devices can be connected to a transducer that will send signals to the controller when changes occur to assist with and/or facilitate system management. The use of a sensor such as a chemical sensor, may be a self-contained device or it can be an interconnected device that can be deployed at a location within the overall process, from harvest to final packaging, in order to provide information about the product, substance, and/or treatment process, such as the chemical composition of the treatment environment. As an example when there is a change in the chemical composition of the monitored environment, analytical molecules inside the device interact selectively with the molecules present in the monitored environment. A transducer connected to this device sends a signal when a change occurs, and systems management can be adjusted in accordance with the programed levels or parameters to achieve the desired substance treatment level which in turn affects the product quality, safety, or shelf life outcome.

The use of sensors such as sonar-pulse distance sensing—ultrasonic waves are sent from the sensor and detect a product, light pulses that are reflected by the objects and then detected again by a sensor can very accurately detect products, certain substances and quality aspects relevant to the substance and product treatments, infrared and thermal sensors can be used to detect conditions, such as the presence of a product or conditions on the products surface that are not visible to the human eye; image sensors can detect and convey information (about a product or capture a specific system aspect) of what constitutes an image. It is done by converting the variable attenuation of light waves into signals. These are used in the cameras which the system uses to create a digital image of the pictures taken by the interconnected camera device(s). That can be used for various purposes such as thermography, creation of multispectral images, sensor arrays for x-rays and other highly sensitive arrays for detecting aspects of the product, levels of contamination and/or the presence of microorganisms as well as providing data for managing product and substance treatments.

According to embodiments, sensor technology may be implemented to measure microorganism levels, presence of or remaining levels of a substance(s) used in the treatments, or coating performance levels and would make AI corrections in the application of the substance treatment to obtain preferred results. According to embodiments, the method of using a substance to treat a perishable product may include measuring the presence of and/or amounts of microbes present on the surface of the perishable product, either before or after application of the substance. According to embodiments, an additional application of the substance may occur when the presence and/or amount of microbes is above a specified amount. According to embodiments, luminescence or other technology could be used to measure the amount or % coverage of substance on a product surface, remaining active substance or treatment ingredient level. Based on results, the process may make self-corrections or adjustments to improve performance. According to embodiments, sensor technology may be used to detect defects on the surface. According to embodiments, vision technology may identify or illuminate a spot on the product for treatment. According to embodiments, bioluminescence or similar technique may be used to determine treatment level or adjustment needed. Substance treatment may then be spot treated on the defect, thus alleviating problems associated with the current methods of defect removal, which end up removing a large percentage of good products in addition to the actual defect.

Through extensive study, the inventor has determined that the selection and combination of functional compounds for substance treatment may be selected based on a number factors, including but not limited to the purpose of the treatment, whether a wet or dry treatment should be applied to the product between harvesting, production and final packing, whether a sanitizing pre-wash treatment is used or needed, whether a final sanitizing surface treatment is used or needed, whether the final surface condition is wet or dry, whether there is a peel treatment and/or coating, the desired odor flavor contribution desired if any, whether there will be a wash or rinse step after the substance treatment, and whether there is a drying step after the substance treatment.

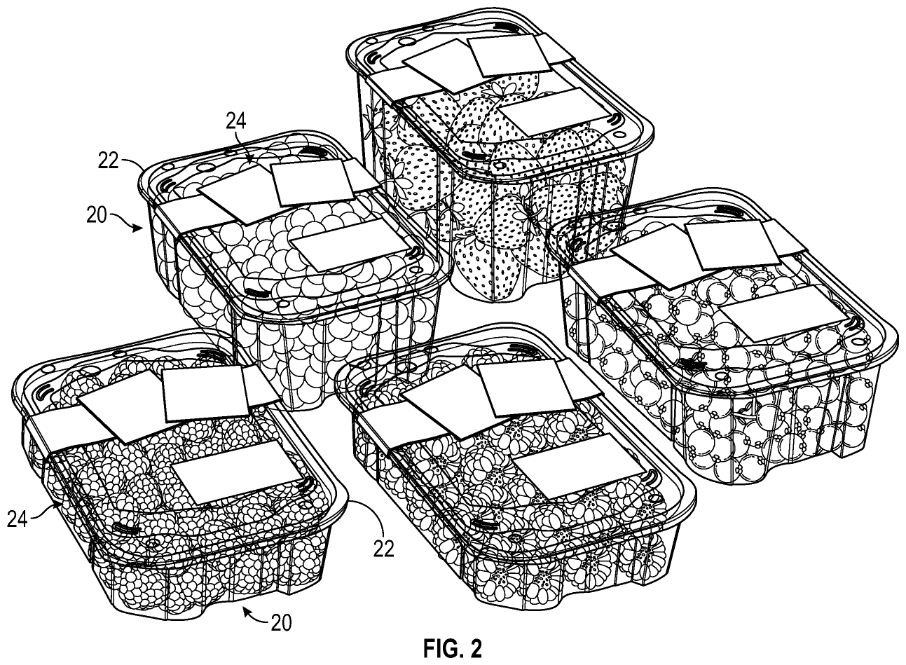

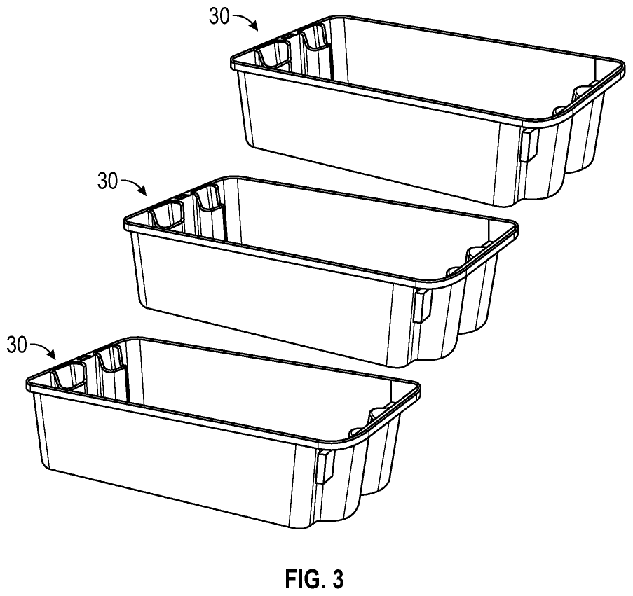

According to embodiments, the perishable product may be packed in a novel package, which may be used for cooling, treatment and packing. According to embodiments, the package may be a punnet or clamshell package with attached or separated lids. According to an exemplary embodiment of FIG. 2, the punnet 20 may have a top flange 22 where film 24 is sealed to enclose the product. According to embodiments, the punnet may or may not be vented. According to embodiments, the top film may be vented, micro-perforated or designed for proper transpiration of oxygen and carbon dioxide (e.g., proper oxygen transmission ratio OTR). According to embodiments, and as shown in FIG. 3, the punnet 30 may have a physical design to support nesting before use and then stacking when filled with the perishable product. According to embodiments, at harvest, the punnets may be filled and stacked within a transportation container. According to embodiments, if vented, the punnets may be cooled in forced air cooling, such as in a cooling tunnel. Preferable for both vented and not vented is de-nesting the punnets on a conveyor and then passing through a cooling tunnel. During the cooling step, the product is treated with sanitizer. Following cooling, the punnets have the lidding film sealed on the top flange. Immediately prior to or at the moment of sealing, a substance treatment may be applied. According to embodiments, the punnets are designed to be more environmentally friendly in terms of less material use and compostable, and may virtually eliminate plastic. According to embodiments, the punnets mirror the common footprint of PET punnets, so customers can avoid additional investments in tooling, and allow customers to easily swap in and out of compostable punnets without having to experience down time.

Treatment in concert with the cooling step can be applied using multiple and/or sequential combinations of substances and treatment applications devices. Because the punnet surface may be “dry” to afford proper film sealing, the use of directed air/gas carried substances treatments, low volume electrostatic spray or nebulized substances such as essential oils minimize moisture present in this step. Embodiments of the punnet in combination with the system and methods described herein facilitate at least: 1) better and more efficient cooling dynamics 2) more effective and efficient directed substance treatments of the product, 3) uses sensors, programming, feedback loops and management control processes to improve the process, 4) use less energy for cooling, 5) generate less waste and a smaller environmental impact. All of these improvements individually and/or collectively are significant when compared with the current method of field packaged berries in clamshells and boxes, that are palletized then tarp forced air cooled.

According to embodiments, the perishable product may be minimally processed foods, consumer products, bulk or wholesale products, raw products, and/or ingredients for food and beverages. According to embodiments, the perishable product may be a protein, such as meat, foul, fish, or vegetable protein. According to embodiments, the perishable product may be a leafy vegetable, such as lettuce. According to embodiments, the perishable product may be berries. According to embodiments, the perishable product may be a stone fruit, such as peaches, plums, and cherries. According to embodiments, the perishable product may be a floral product, including fresh cut flowers or herbs. According to embodiments, the perishable product may be cannabis or hemp.

### Examples

The following embodiments were selected as they represent the greatest need in the industry. However, the embodiments do not limit the invention, and the principles apply to a wide range of perishable products.

Berries

Processing and treatment of berries is an unmet need. Berries are extremely sensitive to rapid mold growth, where any excess moisture or surface water present will result in reduced shelf life and accelerated spoilage. Thus, washing or sanitizing berries becomes extremely challenging due to the risk of rapid mold growth. Additionally, the berry industry needs new packaging that are both sustainable and reduce costs.

In view of the above unmet needs, embodiments of the present invention include a new and improved punnet, tray design, and inline method for cooling and substance treatments, lidding, weighing, labeling, and boxing/casing of products such as berries. The embodiments of the invention result in better and more efficient cooling dynamics, more effective and efficient directed substance treatments of the product, uses sensors, programming, feedback loops and management control processes to improve the current process, uses less energy for cooling, and generates less waste and a smaller environmental impact.

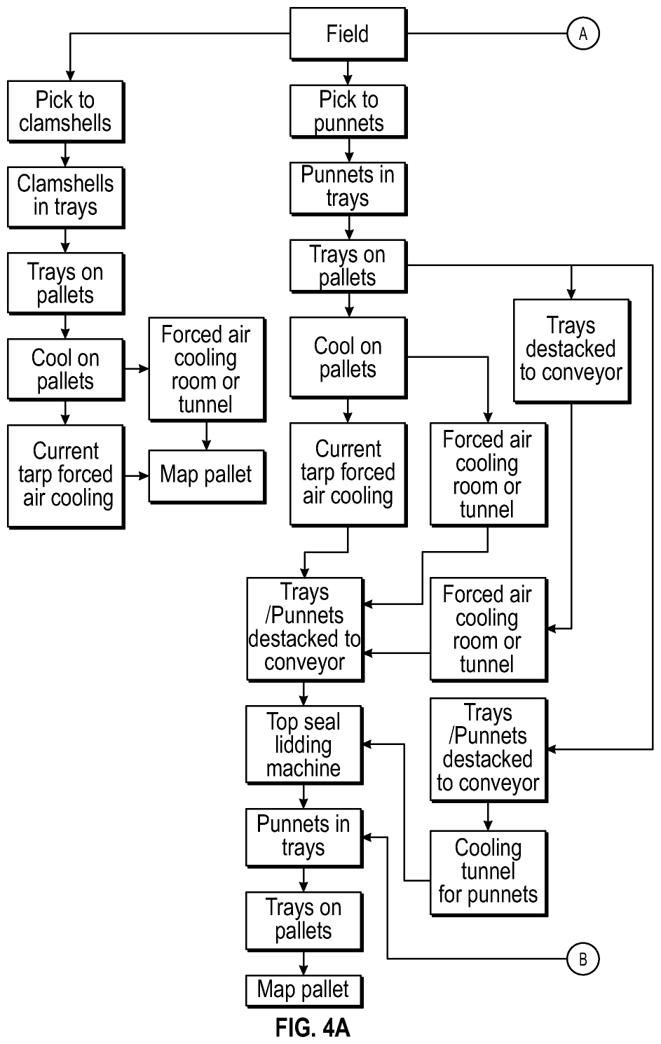

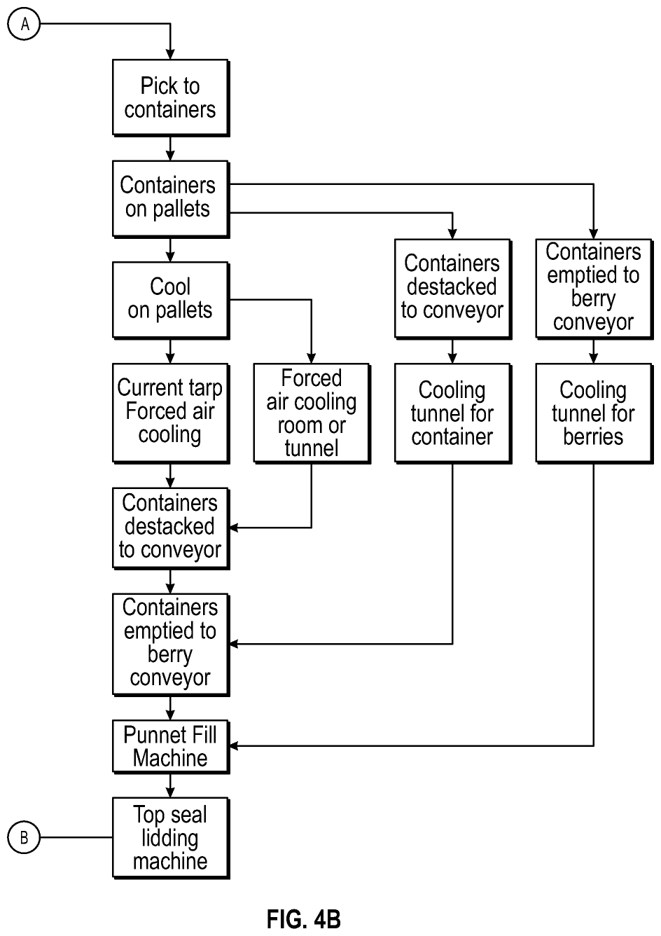

As shown in FIGS. 4 and 5, substance treatment may be applied at various locations along the berry processing line. According to embodiments, a substance treatment may be applied to berries as an atomized and/or electrostatic spray with sanitizer on the berries prior to or during harvesting into punnet, as a substance+sanitizer application during transit or consolidation in truck/trailer/container in covered pallets, in a cooling in-feed conveyor, in initial zone of cooling tunnel or initial stage of cooling, in finishing zone of cooling tunnel or final stage of cooling, prior to or within punnet lid sealing machine, in modified atmosphere, or a combination thereof. For example, as shown in FIGS. 4A and 4B, a process for applying a substance treatment to a perishable product in a punnet with a lidding film process is shown. The process may be in a cooling tunnel or room. In FIG. 5, an exemplary processing line is shown. The processing line may include a wash system 500, an inspection and trim line 502, rollers and pre-treatment spray/electrostatic bars 504, an air knife and electrostatic product treatment cabinet 506, an elevator conveyor to a scale filler 508, a scale filler and electrostatic substance treatment 510, a scale tray with loader 512, a transfer conveyor and treated product trays 514, a MAP sealer for the trays 516, a transfer conveyor with sealed trays 518, a metal detector 520, and a pack table 522. Any of the components of the processing line in FIG. 5 may be re-arranged and/or optional.

TABLE 1
Locations for berry substance application

| Treatment | Berry Process and substance | | | | | |
|---|---|---|---|---|---|---|
| Location | application | Purpose | Carrier | Sanitizer | Surfactant | Emulsifier |
| 1 | Fog or Atomized spray of substance | Control the growth of mold on the | Ionized Water | X | X | |
| | with sanitizer on product in punnet | fruit | | | | |
| | or container | | | | | |
| 2 | Cover pallet, lightly seal, and inject | Add sanitizer to reduce | Air | X | | |
| | substance treatments | microorganism counts | | | | |
| 3 | substance pre-treatment of product | Add sanitizer to reduce | Ionized Water | X | X | |
| | in punnet or container on conveyor | microorganism counts | | | | |
| 4 | substance treatment in zone 1 of | recirculate substances focusing on | Air | X | | X |
| | cooing tunnel or initial stage of | sanitization in air | Humidity via | | | |
| | cooling | | Ionized Water | | | |
| 5 | substance treatment in zone 2 of | recirculate substances focusing on | Air | X | | X |
| | cooing tunnd or find stage of | enhanced quality in air | Humidity via | | | |
| | cooling | | Ionized Water | | | |
| 6 | substance treatment within punnet | durable sanitiation substance and | Air | X | | X |
| | lid sealing machine | enhanced quality | | | | |
| 7 | MAP Pallet prior to shipment | Reduce respiration and | Nitrogen | X | | X |
| | | senescence and ehance aromatics | | | | |
| | Treatment | Essential | | Buffering | Mineral | Aroma/Flavor |
| | Location | Oils | Humectant | Agent | Salts | Compounds |
| | 1 | | | X | X | |
| | 2 | X | | | | |
| | 3 | | | X | | |
| | 4 | X | | | | |
| | 5 | X | X | | | |
| | 6 | X | X | | | X |
| | 7 | X | | | | X |

According to an embodiment, a substance treatment is applied to picked berries, such as strawberries, raspberries, blackberries, blueberries and the like. According to embodiments, the substance may be a sanitizer. According to embodiments, the substance may be applied at the cooling cycle. According to embodiments, an additional substance treatment is applied in forced air cooling of berries in a controlled room. For example, the substance treatment may reduce dehydration during 2-4 hour cooling time while providing surface treatment to reduce mold spore counts. According to embodiments, the substance treatment reduces mold spore count. According to embodiments, the substance treatment reduces dehydration. According to embodiments, the substance is applied using an electrostatic spray nozzle.

A first substance treatment may be applied to berries at field level by using localized fog application with electrostatic charge. The electrostatic fog treatment will maximize fruit coverage, use minimal moisture, and result in minimal loss of material to waste in field. The substance treatment includes a sanitizer to immediately reduce mold and fungus microorganism counts, such as acidic water or peroxyacetic acid. The substance treatment also includes potassium sorbate mineral salt to stop growth of fungus and mold, and ascorbic acid to reduce decay in any cuts.

A second substance treatment may be a gaseous treatment delivered inside the pallet fitted with a protective covering for temporary containment of product and on location or in transit substance treatments, but a sealed enclosure is not required or desired (due to the field heat and berry temperature at this point in the process) when berries are packed just after harvest. The gaseous treatment sanitizes the berry surface, and may include ozone to immediately reduce mold and fungus microorganisms. The ozone is typically 0.03 ppm to 3 ppm level, although higher ppm ozone for shock treatment is possible. The substance treatment also includes grapefruit essential oil to provide durable function during post-harvest period until delivery of the berries to the cooling and packing facility.

A third substance treatment may be a localized fog application with electrostatic charge of substance when the berries in punnet or crates are dumped onto conveyor prior to the cooling tunnel. The electrostatic treatment will maximize fruit coverage, use minimal moisture to inhibit mold, and result in minimal loss of material to waste in production area. The substance treatment includes a sanitizer to immediately reduce mold and fungus microorganisms, such as acid water and peroxyacetic acid. The substance treatment also includes ascorbic acid to reduce decay in cuts.

A fourth substance treatment may be a gaseous treatment delivered inside the cooling system, enabling recirculation of substances to contact berry surface during retention time in the cooling system. The gaseous treatment sanitizers the berry surface, and includes ozone to immediately reduce mold and fungus microorganisms. The ozone is typically 0.03 ppm to 3 ppm level, although higher ppm ozone for shock treatment is possible. The substance treatment also includes grapefruit essential oil to provide additional antifungal function, and humidity via acidified or alkaline water vapor.

A fifth substance treatment may be a gaseous treatment delivered inside the cooling system, enabling recirculation of substances to contact berry surface during retention time in the cooling system. The gaseous treatment sanitizes the berry surface, and includes ozone to immediately reduce mold and fungus microorganisms. The ozone is typically 0.03 ppm to 3 ppm level, although higher ppm ozone for shock treatment is possible. The substance treatment also includes grapefruit essential oil to provide additional antifungal function, and humidity via acidified or alkaline water vapor.

A sixth substance treatment may be a gaseous treatment delivered into the final packaging after cooling, enabling substances to remain in contact with the berry surface during its shelf life. The gaseous treatment sanitizes the berry surface, and includes ozone to immediately reduce mold and fungus microorganisms. The ozone is typically 0.03 ppm to 3 ppm level, although higher ppm ozone for shock treatment is possible. The substance treatment also includes grapefruit essential oil to provide additional antifungal function, glycerin as a humectant, berry essence for aroma, and butyl acetate for aroma and improved product appearance and anti-fungal activity.

A seventh substance treatment may be applied when the berries are packed on a pallet. The berries are packed on a pallet with a modified atmosphere as the berries are awaiting final shipment to customers. The substance treatment includes ozone, grapefruit essential oil, and aromatic substances such as berry essence. The substance treatment reduces microorganism levels, reduces respiration and suppresses mold growth.

One or more of the above substance treatments may be used alone or in combination with each other. Additional substance treatments may be added to the production line as needed to achieve the desired effect.

Proteins

According to an embodiment, a substance treatment is applied to uncooked proteins (meat, fish, foul, and vegetable proteins) prior to packaging. According to embodiments, the protein is cubed or ground meat. According to embodiments, the one or more substances are directly applied to the surface of a protein product via directed and electrostatically assisted treatment. According to an embodiment, the substance treatment comprises a barrier or sanitizer solution, anti-fungal, essence, or combinations thereof. According to embodiments, the substance treatment may include a solution base of ionized (acidified water) for sanitation, functional limonene from citrus oil for cleaning, and thyme oil and rosemary oil for anti-fungal. According to embodiments, the substance is applied using an electrostatic spray nozzle. According to embodiments, the substance is applied in a tunnel.

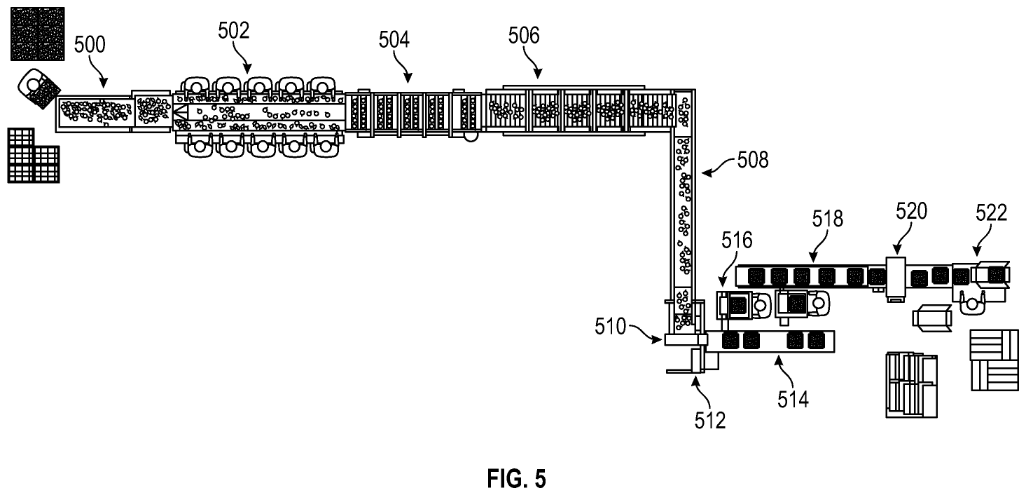

As shown in FIG. 6, substance treatments may be applied at various locations along an existing protein processing line. Although shown in a meat product factory, the process may be for any perishable good. According to an embodiment, the substance is applied at 601 to incoming raw materials to avoid or prevent outside contamination. According to an embodiment, the substance may be applied at 602 on a conveyor after cutting and sorting of the protein to protect the newly exposed surfaces. According to an embodiment, the substance may be applied at 603 or 604 on a conveyor after cutting prior to packing. According to embodiments, the substance may be applied as a final barrier protection for surface contamination. According to embodiments, various substances may be applied at different points (e.g., at 605, 606, 607) of the processing line. According to an embodiment, functional ingredients may be added at 605 in an existing spray. According to embodiments, a final barrier protection for surface contamination may be applied at 606. According to embodiments, newly cut surfaces may be treated at 607 on lower quality content.

TABLE 2
Locations for protein substance application

| | | | | | | | | | | Aroma/ |
|---|---|---|---|---|---|---|---|---|---|---|
| | Protein Process and substance | Treatment | | | | | Essential | | Buffering | Flavor |
| Step | application | Type | Carrier | Sanitizer | Surfactant | Emulsifier | Oils | Humectant | Agent | Compounds |
| 1 | Process line conveyor with | Process | Water | X | X | | | | | |
| | incoming raw materials-prevent | Aid | | | | | | | | |
| | outside contamination | | | | | | | | | |
| 2 | Conveyor after cutting and sorting- | Process | Water | X | X | | | | | |
| | new product surfaces exposed | Aid | | | | | | | | |
| | and protect from person or cutting | | | | | | | | | |
| | contamination | | | | | | | | | |
| 3 | Conveyor after cutting prior to | Residual | Water | X | | X | X | | | X |
| | packing | | | | | | | | | |
| 4 | Conveyor after cutting and prior to | Residual | Water | X | | X | X | | | X |
| | packing | | | | | | | | | |
| 5 | Added functional ingredients in | Residual | Water | X | | X | X | | | X |
| | existing spray | | | | | | | | | |
| 6 | Final barrier protection for surface | Residual | Air or | X | | X | X | | | X |
| | contamination | | Water | | | | | | | |
| 7 | Treat new cut surfaces on lower | Residual | Air or | | | | | | | |
| | quality content | | Water | X | | X | X | | | X |

Vegetables

According to an embodiment, a substance treatment is applied to vegetables. According to an embodiment, substance treatment is applied to leafy vegetables, such as lettuce, spinach, kale, chard, arugula, and the like. According to embodiments, the leafy vegetables are salad greens (i.e., “triple washed” bagged lettuce). According to an embodiment, the substance is applied using an electrostatic spray nozzle. According to embodiments, the electrostatic spray nozzle is located at a conveyor feed belt discharge to dryer. According to embodiments, the electrostatic spray nozzle is located in the centrifugal dryer. According to embodiments, the one or more substances are applied to the leafy vegetable via directed and electrostatically assisted treatment. According to embodiments, the substance is applied using an electrostatic spray nozzle.

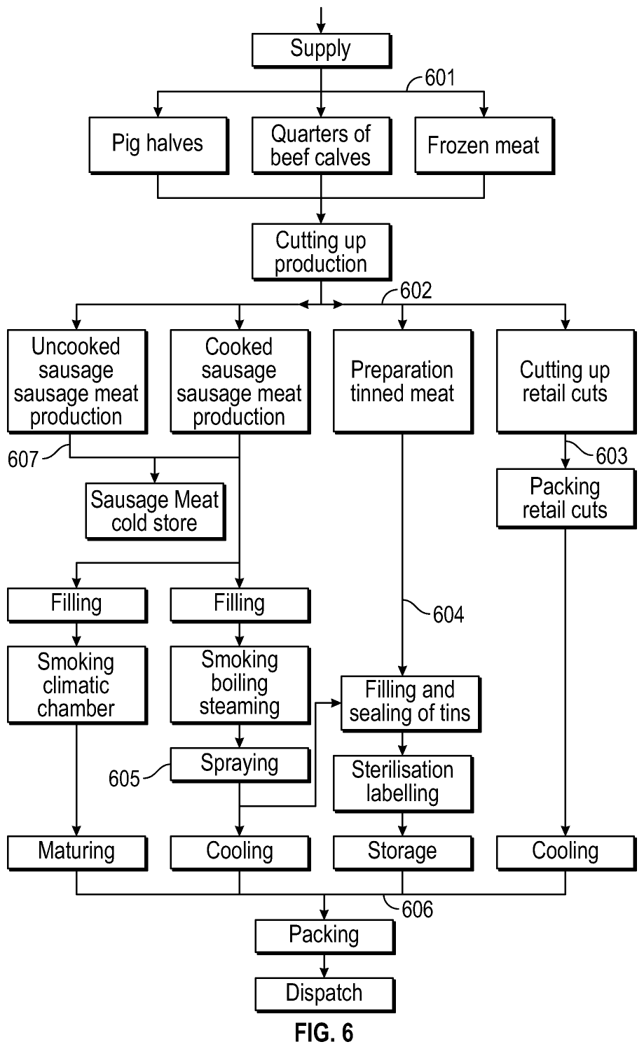

As shown in FIG. 7, substance treatments may be applied at various locations along an existing vegetable processing line. According to an embodiment, the substance is applied to incoming raw materials to avoid outside contamination. According to an embodiment, the substance may be applied after cutting to protect the newly exposed surfaces. According to embodiments, substance treatment may be applied at 701 on a process line conveyor with cut lettuce. According to an embodiment, nitrogen is added at 702 to the chamber and fills bins, added at 703 as a local injection of components to a bin as it is sealed, added at 704 to or within the cutting machine, added at 705 to flume or belt wash system, added at 706 at feed or inside drying machine, added at 707 as a final treatment on conveyor or as bin is discharged onto packing equipment weigh scales, or a combination thereof. According to embodiments, various substances may be applied at different points of the processing line. Although shown for a leafy green application, the process may be applied to any perishable product.

TABLE 3
Locations for leafy green substance application

| | Lettuce Process and | Treatment | | | | Essential | | Buffering | Mineral | Aroma/Flavor |
|---|---|---|---|---|---|---|---|---|---|---|
| Step | substance application | Type | Carrier | Sanitizer | Surfactant | Oils | Humectant | Agent | Salts | Compounds |
| 1 | Process line conveyor with | Process Aid | Water | X | X | | | X | X | |
| | cut lettuce | | | | | | | | | |
| 2 | Apply functional components | Process Aid | Nitrogen | X | | | | | | |
| | as N2 is added to chamber | | | | | | | | | |
| | and fills bins | | | | | | | | | |
| 3 | Local injection of | Process Aid | Nitrogen | X | | X | | | | |
| | components to a bin as it is | | | | | | | | | |
| | sealed. | | | | | | | | | |
| 4 | Applied in the cutting | Process Aid | Water | X | X | | | | | |
| | machine itself | | | | | | | | | |
| 5 | Added functional ingredients | Process Aid | Water | X | X | | | | | |
| | to flume or belt wash system | | | | | | | | | |
| 6 | Added at feed or inside | Residual | Air or | X | | X | | X | | X |
| | drying machine | | Water | | | | | | | |
| 7 | Final treatment on conveyor | Residual | Air | | | X | X | X | X | X |
| | or as bin is discharged onto | | | | | | | | | |
| | packing equipment weigh | | | | | | | | | |
| | scales | | | | | | | | | |

Fresh Tomatoes

Processing and treatment of tomatoes, including grape and cherry tomatoes, is an unmet need. Presently, the only treatment that, for example, cherry tomatoes receive is a spray wash with brushing to remove surface debris. Cherry tomatoes are generally handpicked and have bruising, picking scar and/or ripeness defects. The surface defects are vulnerable to mold/decay. Tomatoes contain spoilage microorganisms, such as Pseudomonads, yeast, mold, Bacillus, Erminia, Xanthomonas, and Clostridium spp. Tomatoes have also been recalled for Salmonella contamination. Tomatoes are also especially susceptible to dehydration and cross-contamination during cooling.

In view of the above unmet needs, embodiments of the present invention reduce micro-organism counts and enhance health of tomato skin and surface defects by identifying points of tomato processing to incorporate novel substance treatments. As shown in FIG., substance treatments may be applied at various locations along an existing tomato processing line. According to embodiments, a substance treatment may be applied to tomato plants in the greenhouse at 801, a spray wash at 802 prior to cooling, a spray wash and ozone treatment at 803 within the cooling tunnel, an electrostatic spray treatment just prior to a wash step at 804, an electrostatic spray as tomatoes are conveyed to packing at 805, in the cold storage room at 806 to prevent mold on refrigeration and cooler surface, in modified atmosphere (MAP) pallet at 807, or a combination thereof. According to embodiments, the substance treatment may be vision technology assisted for treatment of defects.

TABLE 4
Locations for tomato substance application

| Treatment | | |
|---|---|---|
| Location | Tomato Process and substance application | Description |
| 1 | Pre-harvest treatment of tomato plant | Fog treatment of sanitizer and/or |
| | | essential oil to the plant to prevent |
| | | fungus and mold development |
| 2 | Add electrostatic spray wash with ionized | Washing chamber with electrostatic |
| | water prior to cooling | spray to get initial surface coating of sanitizer |
| 3 | Add spray wash within cooling tunnel | During cooling, use automatic software |
| | | program or manual process settings to |
| | Ozone Treatment | apply sanitizer substance for continued |
| | | contact with tomato surfaces |
| 4 | Add electrostatic spray treatment | Highly active sanitizer to significantly |
| | just prior to current wash step | reduce micro-organism counts: |
| 5a | Electrostatic spray on conveyor to packing | During the transfer via conveyor to be |
| | | packed, electrostatic spray light surface treatment |
| 5b | Electrostatic spray using Vision Assist | |
| 6 | In the cold storage room, during facility | Use program settings. Inject at inlet |
| | sanitation period | to recirculating air fans to treat heat |
| | Ozone Treatment | exchange surface and distribute throughout cold room |
| 7 | MAP Pallet prior to shipment | MAP Prior art: wrap/seal the product |
| | | within the pallet: apply N₂ |
| | | and other substance treatment. |

| Treatment | | |
|---|---|---|
| Location | Process | Decision |
| 1 | Localized fogging of electrostatic | Surface coating of the substance on the leaves |
| | charged substance at the plant in | and fruit provides a barrier to development of |
| | the greenhouse | fungus and mold. Minimal residual moisture desired. |
| 2 | Tomatoes in harvest trays, stacked | Receiving dock will have limited ability to drain |
| | on pallet on receiving dock | high volumes of liquid, so only a surface treatment |
| | | with less expensive sanitizer substance. |
| 3 | Pallets in high air flow | Cool room concenrates air flow around pallets. |
| | cooling room | During the cooling time, able to apply sanitizer |
| | | in a way it will reach the tomato surfaces while |
| | | also maintaining a clean room. High room volume |
| | | dictates only use of a less expensive |
| | | sanitizer substance. |
| 4 | Tomatoes entering the | Some microorganisms are only effected by highly |
| | wash tunnel | active sanitizer. “Burst” application followed |
| | | by low active sanitizer wash provides the intense |
| | | sanitize step and then is diluted to prevent any |
| | | damage to the tomatoes |
| 5a | Tomatoes within a tunnel or on | Intimate and last location to treat tomatoes. |
| | exposed conveyor in Refrigerated | Treatment to have immediate and longer lasting |
| | Warehouse | efficacy. Intimacy enables optimal use and |
| | | minimal waste of more expensive substances. |
| 5b | | |
| 6 | Sanitizers work on microorganisms | Careful use of gas sanitizer like ozone and |
| | on refrigeration and wall surfaces | liquid substance like essential oil to maintain |
| | | clean ceiling, walls, and equipment surfaces during |
| | | operation. Can be directed near pallet storage. |
| 7 | Pallet wrapping system in | All substances applied within the sealed enclosure. |
| | Refrigerated Warehouse | Substances can have an immediate and longer lasting |
| | | efficacy. Cost effective use of aromatic substances. |

TABLE 5
Locations for tomato substance application

| Treatment | Tomato Process and substance | | | | | |
|---|---|---|---|---|---|---|
| Location | Application | Purpose | Carrier | Sanitizer | Surfactant | Emulsifier |
| 1 | Pre-harvest treatment of tomato | Control the growth of mold on the | Air | X | X | X |
| | plant | leaves and tomatoes | | | | |
| 2 | Add spray wash with ionized water | Add sanitizer to reduce microorganism | Water | X | X | |
| | prior to cooling | counts | | | | |
| 3 | Add spray wash within cooling | Add sanitizer to reduce microorganism | Water | X | X | |
| | tunnel | counts | | | | |
| | Ozone Treatment | Add sanitizer to reduce microorganism | Recirculating | X | | |
| | | counts | Air | | | |
| 4 | Add electrostatic spray treatment | Intense or high active sanitation | Water | X | X | X |
| | just prior to current wash step | treatment moments before tomatoes | | | | |
| | | are washed and rinsed | | | | |
| 5a | Electrostatic spray on conveyor to | Add sanitizer to reduce microorganism | Air | X | | X |
| | packing | counts; humectant and buffering | | | | |
| | | agent to reduce dehydration and | | | | |
| | | senescence | | | | |
| 5b | Electrostatic spray using Vision Assist | Add sanitizer to reduce microorganism | Air | X | | X |
| | | counts; humectant and buffering | | | | |
| | | agent to reduce dehydration and | | | | |
| | | senescence | | | | |
| 6 | In the cold storage room, during | Reduce cross-contamination | Water | X | | X |
| | facility sanitation period | | | | | |
| | Ozone Treatment | Add sanitizer to reduce microorganism | Air | X | | |
| | | counts | | | | |
| 7 | MAP Pallet prior to shipment | Reduce respiration and senescence | Nitrogen | X | | X |
| | | and ehance aromatics | | | | |
| | Treatment | Essential | | Buffering | Mineral | Aroma/Flavor |
| | Location | Oils | Humectant | Agent | Salts | Compounds |
| | 1 | X | | | | |
| | 2 | | | | | |
| | 3 | | | X | | |
| | 4 | | | | | |
| | 5a | X | X | X | | |
| | 5b | X | X | X | X | |
| | 6 | X | | | | |
| | 7 | X | | X | | X |

TABLE 6
Locations for pre-cut tomato substance application

| | | | | | | | | | | Aroma/ |
|---|---|---|---|---|---|---|---|---|---|---|
| | Tomato Process and substance | Treatment | | | | | Essential | | Buffering | Flavor |
| Step | application | Type | Carrier | Sanitizer | Surfactant | Emulsifier | Oils | Humectant | Agent | Compounds |
| 1 | Apply in the slicing machine to | Process | Water | X | X | | | | X | |
| | surface treat the slices and the | Aid | | | | | | | | |
| | slicing blades. | | | | | | | | | |
| 2 | Apply to the dices following the | Residual | Air or | X | | | X | | X | |
| | flume as they release excess water | | Water | | | | | | | |
| | and move to packing steps. | | | | | | | | | |
| 3 | Apply in the weigh | Residual | Air or | X | | | X | | X | |
| | scales to sanitize | | Water | | | | | | | |
| | surface | | | | | | | | | |
| 4 | Apply on the top of the diced | Residual | Air or | X | | | X | | X | |
| | tomatoes in the tray | | Water | | | | | | | |
| | before the film | | | | | | | | | |
| | seal is applied. | | | | | | | | | |

According to an embodiment, substance treatment may be applied to fresh tomatoes, including pre-cut fresh tomatoes to reduce mold and other pathogens. According to an embodiment, the tomatoes are cherry or grape tomatoes. According to an embodiment, the tomatoes are roma or round tomatoes. According to embodiments, the substance is a sanitizer. According to embodiments, the one or more substances are applied through an electrostatic spray nozzle.

According to embodiments, the substance treatment may be applied after harvest. According to embodiments, the substance treatment may be applied after a spray wash. According to embodiments, the spray wash may be changed to an electrostatic spray and ionized water with additional treatment components. According to embodiments, the one or more substances may be added into final rinse and dry step. According to embodiments, the one or more substances may be applied after handling and processing prior to packing. According to embodiments, the one or more substances may be applied prior to applying a wax. According to embodiments, the one or more substances may be applied in the ripening room to reduce mold count in cold storage. According to embodiments, the one or more substance treatments may be applied in the cold storage room to prevent mold on refrigeration and cooler surfaces.

According to embodiments, the one or more substances may be applied in the slicing machine to surface treat the slices and the slicing blade. According to embodiments, the one or more substances may be applied to the dices following the fume as they release excess water and move to packing steps. According to embodiments, the one or more substances may be applied to the weigh scales to sanitize the surfaces. According to embodiments, the one or more substances may be applied on the top of the diced tomatoes in the tray before the film seal is applied.

A first substance treatment may be applied as a localized fog application with an electrostatic charge on tomato plants in the greenhouse pre or during harvest. The electrostatic charge of the substance will maximize plant and fruit coverage, use minimal moisture, and provide for minimal loss of material to general warehouse space. The substance treatment includes a sanitizer to immediately reduce mold and fungus microorganism counts, such as peroxyacetic acid. The substance treatment also includes a durable antifungal, that is, an antifungal that will remain on the surface of the tomato to prevent mold and fungus from developing, such as grapefruit essential oil and potassium sorbate mineral salt. The substance treatment is applied dry or mostly dry to avoid additional fungus and mold growth issues.

A second substance treatment may be a spray wash with a substance solution applied to the harvested tomatoes prior to cooling. The second substance treatment applies a sanitizer and surfactant to the tomato surface. The substance treatment includes a sanitizer to immediately reduce mold and microorganism counts, such as peroxyacetic acids. The substance treatment also includes a surfactant, such as potassium oleate. The surfactant will enhance efficacy of the sanitizer and further sanitizing steps.

A third substance treatment may be applied in an enclosed tunnel during cooling of the tomatoes. The treatment is a spray wash atomized or volatilized in recirculating air. Ozone is distributed in the recirculating air. A software based program leverages feedback from sensors to control the substance and ozone feed rates. Feedback includes detection and measurement of microorganisms on the tomatoes, product temperature, substance and ozone feed rates, and ozone levels in the recirculating air. The substance treatment includes a sanitizer to immediately reduce mold and microorganism counts, such as ozone and peroxyacetic acid. Additional functional substances include potassium oleate as a surfactant and a buffering agent.

The treatment system is integrated with the cooling process. Treatment function control is slave to the cooling room operation such that if the doors are open and/or the air cooling system is not operating, then the treatment system is off. Once the doors to the cooling room are closed and the cooling process is turned on, then the treatment system also powers up. Program settings may be manual or auto. Auto (programmed) settings for temperature and microorganism reduction will determine the amount and sequence of substance and ozone during cooling. Optional manual settings for treatment include ozone only, substance only, or a combination of ozone and substance with low, medium, or high feed rates. For auto control, the system provides the treatment until the temperature and microorganism targets are achieved. The programmed treatment turns off automatically. The manual controlled treatment turns off if the doors are opened or the cooling system is turned off. The operator is able to observe the key indicators of the process. Alarms are present if the supply of substance or any process indicator is out of target range. A record of the treatment is able to be retrieved. This would support the facility HACCP program.

A fourth substance treatment may be applied as an electrostatic spray of tomatoes as they are conveyed just prior to a wash and dry step. The electrostatic spray treatment uses a very strong sanitizer just before the current wash step to maximize coverage and minimize the quantity of substance used to avoid overspray and waste. The substance treatment includes peroxygen bleach, an intense sanitizer to reduce resistant microorganisms. Additional functional substances include potassium oleate as a surfactant, grapefruit essential oil, and a buffering agent. Peroxygen bleach is generally not used despite being an effective sanitizer because it will damage a product such as a tomato. However, by following the application of peroxygen bleach with a wash and dry step, the dwell time of peroxygen bleach may be carefully controlled to minimize any damage to the tomatoes.

Treatment system control is slave to the conveyor and washing operation; if the conveyor or wash system is off, then the treatment system is off. Once the conveyor and wash system are turned on, then the treatment system powers up. Operator sets low/medium/high feed settings. Low/medium/high is determined by QA product inspections for defects and microorganisms and recent shipping results. Once the sensor detects tomatoes are present, then the system provides the treatment flow rate selected (low/medium/high). The treatment turns off if tomatoes are not present or if the conveyor or wash system are turned off. The operator is able to observe the flow rate and pressure of the treatment. The operator is alerted if the treatment container, placed on a weigh load cell, goes below the set point. A record of the treatment is able to be retrieved. This would support the facility HACCP program.

A fifth substance treatment may be applied as an electrostatic spray of tomatoes as they are conveyed just after the wash and dry step, on their way to packing. The electrostatic spray treatment uses a sanitizer with components to provide durable protection to the tomato surface just before the packing step. Vision technology enables directed treatment of defects on the tomato surface. The substance treatment is applied mostly dry to minimize the remaining surface moisture. The substance treatment includes peroxyacetic acid for an additional log reduction of mold/fungus counts. Additional functional substances include grapefruit essential oil, glycerin, potassium sorbate, and potassium bicarbonate.

The treatment system control is slave to the conveyor operation; if the conveyor is off, then the treatment system is off. Once the conveyor is turned on, then the treatment system powers up. Operator sets low/medium/high feed settings. Low/medium/high is determined by QA product inspections for defects and microorganisms, and recent shipping results. Once the sensor detects tomatoes are present, then the system provides the treatment flow rate selected (low/medium/high). The treatment turns off if tomatoes are not present or if the conveyor is turned off. The operator is able to observe the flow rate and pressure of the treatment. The operator is alerted if the treatment container, placed on a weigh load cell, goes below the set point. A record of the treatment is able to be retrieved. This would support the facility HACCP program.

A vision system can be integrated into the system to detect defects on the surface of the tomato and apply an additional substance to the defect. The treatment system control is slave to the conveyor and Vision system operation; if the conveyor and Vision system are off, then the treatment system is off. Once the conveyor and Vision System are turned on, then the treatment system powers up. Operator sets low/medium/high feed settings for both treatment A and B. Low/medium/high is determined by QA product inspections for defects and microorganisms, and recent shipping results. Once the sensor detects tomatoes are present, then the system provides the treatment A flow rate selected (low/medium/high). If the Vision system detects a defect on a tomato, then the on/off valve for the treatment B nozzle applies to the defective tomato. The treatment turns off if tomatoes are not present or if the conveyor is turned off. The operator is able to observe the flow rate and pressure of the treatment. The operator is alerted if the treatment container, placed on a weigh load cell, goes below the set point. A record of the treatment is able to be retrieved. This would support the facility HACCP program.

A sixth substance treatment may be applied as an atomized substance spray on the inlet of the refrigerator in the holding/processing room. Ozone is dispersed at the outlet of the refrigeration equipment to be dispersed throughout the process room. A software program executes controlled release of the substance and ozone. The substance treatment includes peroxyacetic acid and ozone to reduce microorganisms on the surface. Additional functional substances include a surfactant and grapefruit essential oil.

The treatment system control is slave to the cooling equipment operation; if the cooling units are off, then the treatment system is off. The system can be turned on to operate during production or when the facility is idle. Program setting selected for ozone only, substance only, or a combination of ozone and substance. Operator sets low/medium/high feed setting and timer. Then the system provides the treatment flow rate and for the time set. Program setting and low/medium/high determined by QA and Operations for intended purpose, e.g. heavy sanitation or maintenance levels. The program can regulate the amount, sequence, and time of the treatments. The treatment turns off if the cooling equipment shuts off or by Operations or QA. The operator is able to observe the flow rate and pressure of the treatment. The operator is alerted if the treatment container, placed on a weigh load cell, goes below the set point. A record of the treatment is able to be retrieved. This would support the facility HACCP program.

A seventh substance treatment may be applied when the tomatoes are packed on a pallet. The tomatoes are packed on a pallet with a modified atmosphere as the tomatoes are awaiting final shipment to customers. The substance treatment includes ozone, grapefruit essential oil, and aromatic substance 3-hexenal, 4-methyl furan. The substance treatment reduces microorganism levels and reduce respiration and suppress mold growth.

One or more of the above substance treatments may be used alone or in combination with each other. Additional substance treatments may be added to the production line as needed to achieve the desired effect.

Table 7 shows results of sanitization and MAP treatment according to embodiments of the invention, indicating reduced defects due to shrivel, rot, yeast, and mold/decay.

TABLE 7
Results

| BEFORE | | [symbol] | [symbol] | [symbol] | [symbol] | [symbol] | [symbol] | AFTER | | [symbol] | [symbol] | [symbol] | [symbol] | [symbol] | [symbol] |
|---|---|---|---|---|---|---|---|---|---|---|---|---|---|---|---|
| [symbol] | | [symbol] | [symbol] | | | | | [symbol] | | [symbol] | [symbol] | | | | |
| [symbol] | | [symbol] | [symbol] | [symbol] | [symbol] | [symbol] | [symbol] | [symbol] | | [symbol] | [symbol] | [symbol] | [symbol] | [symbol] | [symbol] |
| [symbol] | | | | | | | | [symbol] | | | | | | | |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| [symbol] | [symbol] | | | | | | | | | | | | | | |
| | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |
| | [symbol] | [symbol] | [symbol] | [symbol] | [symbol] | [symbol] | [symbol] | | [symbol] | [symbol] | [symbol] | [symbol] | [symbol] | [symbol] | [symbol] |

[symbol]

indicates data missing or illegible when filed

Avocados

According to an embodiment, substance treatment is applied to the exterior of avocados to reduce pathogens on the surface. According to embodiments, the substance is a sanitizer. According to embodiments, the one or more substances are applied through an electrostatic spray nozzle.

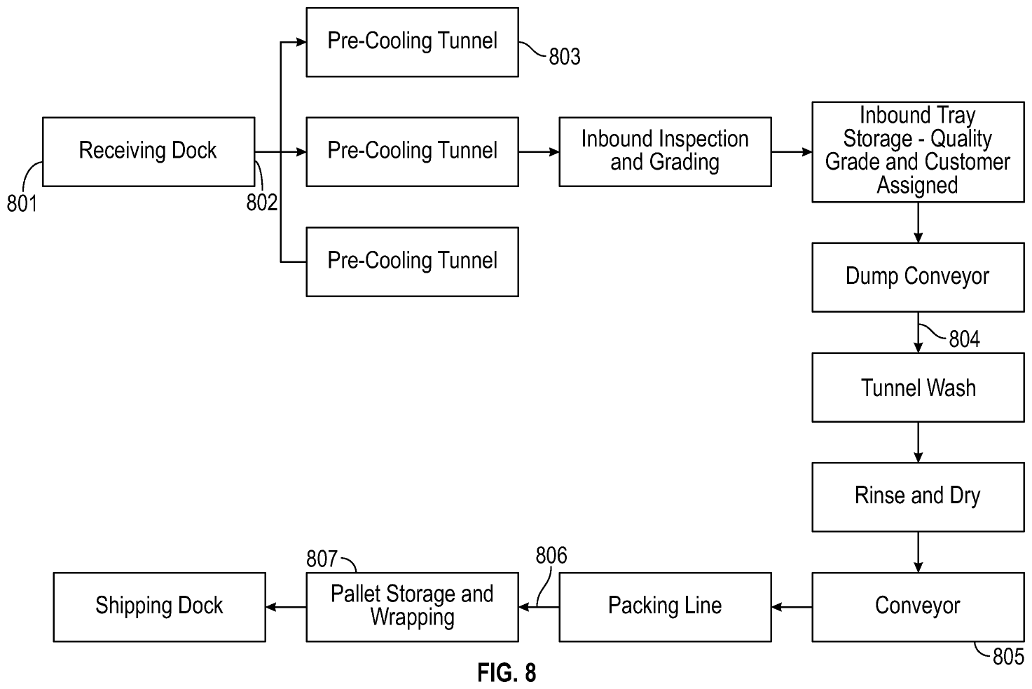

As shown in FIG. 9, substance treatments may be applied at various locations along an existing avocado processing line. According to embodiments, the substance treatment may be applied after harvest. According to embodiments, the substance treatment may be applied after a spray wash. According to embodiments, the spray wash may be changed to an electrostatic spray and ionized water with additional treatment components at 901. According to embodiments, the one or more substances may be added into final rinse and dry step at 902. According to embodiments, the one or more substances may be applied after handling and processing prior to packing at 903. According to embodiments, the one or more substances may be applied before applying a wax. According to embodiments, the one or more substances may be applied in the ripening room to reduce mold count in cold storage at 904. According to embodiments, the one or more substance treatments may be applied in the cold storage room to prevent mold on refrigeration and cooler surfaces.

According to embodiments, the substance may comprise a functional diluent or solvent, including but not limited to ionized water, acidified water, ethanol, isopropyl alcohol, nitrogen, ozone and the like. According to embodiments, the substance may comprise a sanitizer, including but not limited to chlorine dioxide, hydrogen peroxide, peracetic acid, ozone and the like. According to embodiments, the substance treatment may comprise an essential oil, including but not limited to lemon oil, orange oil, grapefruit oil, rosemary oil, sunflower oil, other fruit-derived oils, tea tree oil, cinnamon oil and the like. According to embodiments, the substance may comprise a surfactant including but not limited to potassium oleate, sodium dodecyl sulfate (SDS) and the like. According to embodiments, the substance may comprise a humectant including but not limited to sorbitol, glycerin, glycerol and the like. According to embodiments, the substance may include buffering agents and/or mineral salts including but not limited to ascorbic acid, citric acid, sodium bicarbonate, calcium phosphate and the like. According to embodiments, the substance may include aroma and flavor compounds including but not limited to esters, linear terpenes, cyclic terpenes, alcohols, aldehydes, esters, ketones, lactones, thiols and the like.

TABLE 8
Locations for avocado substance application

| | Avocado Process and substance | | | | |
|---|---|---|---|---|---|
| Step | application | Treatment Type | Carrier | Sanitizer | Surfactant |
| 1 | Process line spray wash step | Process Aid | Water | X | X |
| 2 | Process line final rinse and dry step | Residual | Water | X | |
| 3 | After handling and processing prior | Residual | Water | X | |
| | to packing | | | | |
| 4 | In the cold storage room | Residual | Water | X | |
| | MAP Pallet prior to shipment | Residual | Nitrogen | X | |
| | | Essential | | Buffering | Aroma/Flavor |
| Step | Emulsifier | Oils | Humectant | Agent | Compounds |
| 1 | | | | | |
| 2 | X | X | X | X | |
| 3 | X | X | X | X | |
| 4 | X | X | | | |
| | X | X | | X | X |

Floral Products

Processing and treatment of fresh-cut flowers such as roses is an unmet need. For example, the vast majority of roses come from Colombia, where they are harvested, packed and shipped to North America, where they are held in various facilities before being dispatched to customers across the country. Fresh-cut flowers are highly susceptible to moisture loss and dehydration, but will also mold with moisture and humidity. As such, air transport is necessary, but expensive.

In view of the above unmet needs, embodiments of the present invention provide fungistatic substance treatment for mold reduction and/or a surface coating/wax/surfactant ionic or non-ionic for moisture loss prevention. According to embodiments, substance treatment may include solution bases use ionized (acidified water) for sanitation, functional terpene from citrus oil for cleaning, tea tree oil for anti-fungal, and cinnamon oil for anti-mold. According to embodiments, a substance treatment may be applied to cut flowers prior to or at harvest, in cooling chamber, after handling and processing prior to packing, in the cold storage room to prevent mold on refrigeration and cooler surfaces, and as the flowers are unpacked and placed in display cases. According to embodiments, the floral products may be roses. According to embodiments, a substance treatment may be applied to roses in the greenhouse, to the cut flowers as harvested in carts, to flower ends as they are de-thorned and staged on chutes or in chute tunnels, to stems and leaves in chute tunnel, through packing as they are cooled, and in modified atmosphere stack.

TABLE 9
Locations for floral substance application

| | Floral Process and substance | Treatment | | | | |
|---|---|---|---|---|---|---|
| Step | application | Type | Carrier | Sanitizer | Surfactant | Emulsifier |
| 1 | Apply to cut flowers as prior to | Process Aid | Water | X | | X |
| | or as harvested | | | | | |
| 2 | Apply functional components | Residual | Water | X | | X |
| | into cooling chamber | | | | | |
| 3 | Apply after handling and | Residual | Water | X | | X |
| | processing prior to packing | | | | | |
| 4 | Apply in the cold storage room | Residual | Water | X | | X |
| | to prevent mold on | | | | | |
| | refrigeration and cooler | | | | | |
| 5 | Apply treatment as unpacked | Residual | Water | X | | X |
| | and placed in display case | | | | | |
| | | | | Buffering | Aroma/Flavor | Plant |
| | Step | Essential Oils | Humectant | Agent | Compounds | Nutrition |
| | 1 | X | X | X | | X |
| | 2 | X | X | | | |
| | 3 | X | X | X | X | X |
| | 4 | X | X | X | X | |
| | 5 | X | X | X | X | X |

TABLE 10
Locations for rose substance application

| | Floral Process and substance | Treatment | | | | |
|---|---|---|---|---|---|---|
| Step | application | Type | Carrier | Sanitizer | Surfactant | Emulsifier |
| 1 | Apply with electrostatic | Process Aid | Acidified or | X | | X |
| | fogging in greenhouse | | Alkaline | | | |
| | | | Water | | | |
| 2 | Apply to cut flowers as | Process Aid | Acidified or | X | | X |
| | harvested in carts | | Alkaline | | | |
| | | | Water | | | |
| 3a | Zone 1: Apply to flower ends as | Process Aid | Acidified or | X | | |
| | they are dethorned and staged | | Alkaline | | | |
| | on chutes or in chute tunnel | | Water | | | |
| 3b | Zone 2: Apply to flower ends as | Process Aid | Air | | | |
| | they are dethorned and staged | | Nebulizer | | | |
| | on chutes or in chute tunnel | | | | | |
| 3c | Zone 3: Apply to flower stems | Process Aid | Acidified or | X | | |
| | and leaves on chute or in | | Alkaline | | | |
| | chute tunnel | | Water | | | |
| 4 | Apply through packing as they | Process Aid | Air | | | |
| | are cooled | | | | | |
| 5 | MAP for pallets | Residual | Industrial | X | | |
| | | | Gas | | | |
| | | | | Buffering | Aroma/Flavor | Ethylene |
| | Step | Essential Oils | Humectant | Agent | Compounds | Scavenger |
| | 1 | X | X | X | | X |
| | 2 | X | X | X | | X |
| | 3a | | | X | | X |
| | 3b | X | X | | X | |
| | 3c | | X | X | | X |
| | 4 | X | | | | X |
| | 5 | X | X | | X | X |

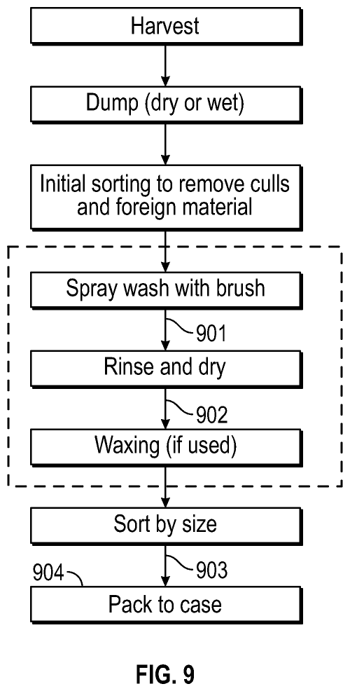

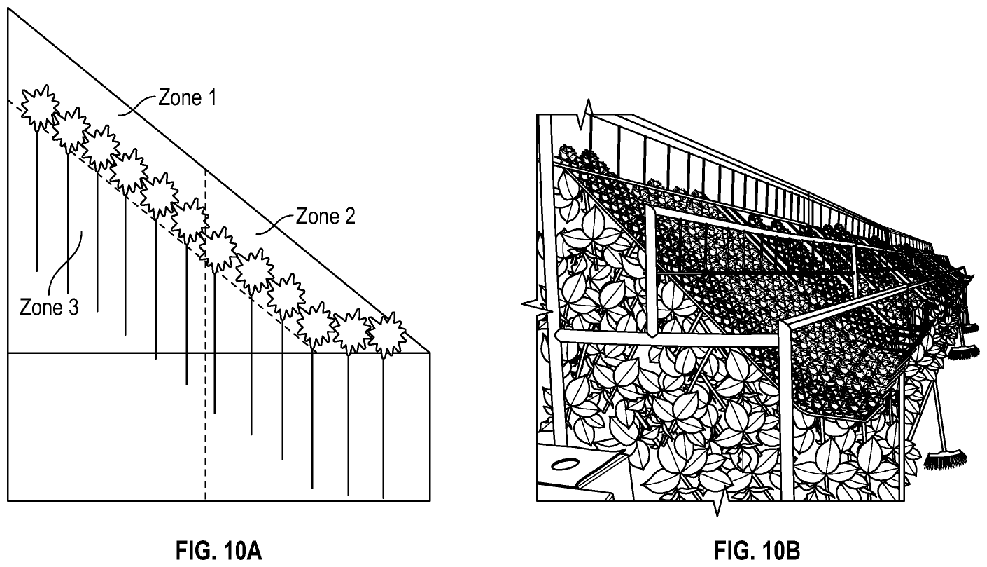

As shown in FIGS. 10A and 10B, substance treatment may be applied to floral products during chute cooling and/or conditioning tunnel. Zone 1 substance treatment may include spectral reflectance measurement, and electrostatic fog application with acidified or alkaline water sanitizer, a humectant, and an ethylene scavenger. Zone 2 substance treatment may include nebulized essential oil application and an aroma essence. Zone 3 substance treatment may include a humectant and an ethylene scavenger.

Cannabis

According to embodiments, substance treatment may be applied to cannabis or other perishable food products to improve the value and quality, and to prevent mold. According to embodiments, substance treatment is applied using electrostatic spray nozzle. According to embodiments, substance treatment is applied using nebulizing diffuser. According to embodiments, substance treatment includes sanitizers. According to embodiments, substance treatment includes terpene and/or terpenoid compounds. According to embodiments, substance treatment includes anti-fungal compounds.

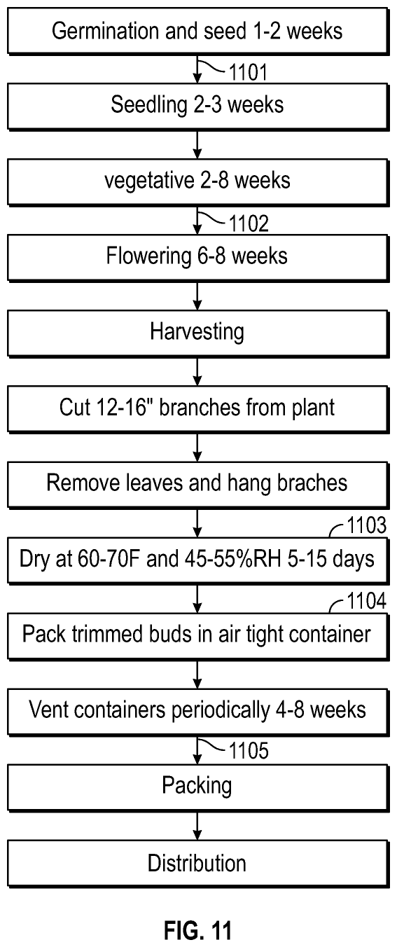

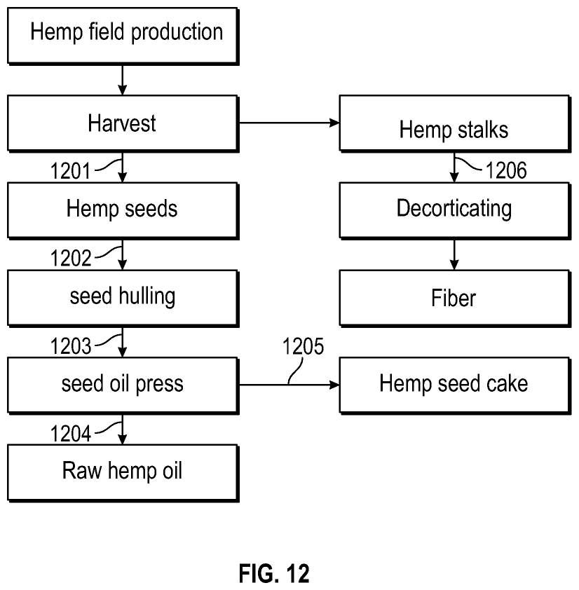

As shown in FIGS. 11 and 12, substance treatments may be applied at various locations along an existing cannabis or hemp processing line. According to embodiments, the one or more substances are applied after harvesting. According to embodiments, substance treatment is applied in a cold room. According to embodiments, substance treatment occurs in a fog tent. According to embodiments, substance treatment occurs in a greenhouse. According to embodiments, substance treatment occurs before drying. According to embodiments, substance treatment occurs before packing. According to embodiments, substance treatment is applied to plants prior to harvesting. According to embodiments, more than one substance treatment may be applied at different points of processing. According to embodiments, the treatment may include anti-mold treatment in the green house at 1101, treatment to prevent leafy mold at 1102, dry treatment for mold prevention at 1102, treatment for mold prevention at 1104, treatment for mold prevention at 1105, or combinations thereof.

According to embodiments, substance treatment is applied to hemp fiber. According to embodiments, substance treatment is applied to hemp seed. According to embodiments, substance treatment is applied to hemp oil.

According to embodiments, the one or more substances may be applied to the seed surface on harvest machine at 1201. According to embodiments, the one or more substances may be applied to the seed in storage containers at 1202. According to embodiments, the one or more substances may be applied on equipment and hulled seeds to prevent mold at 1203. According to embodiments, the one or more substances may be applied after seed oil press to prevent oil from oxidizing at 1204. According to embodiments, the one or more substances may be applied to the seed cake to prevent mold and oxidation at 1205. According to embodiments, the one or more substances may be applied to harvested hemp stalks to prevent mold at 1206.

According to embodiments, the substance may comprise a functional diluent or solvent, including but not limited to ionized water, acidified water, ethanol, isopropyl alcohol, nitrogen, ozone and the like. According to embodiments, the substance may comprise a sanitizer, including but not limited to chlorine dioxide, hydrogen peroxide, peracetic acid, ozone and the like. According to embodiments, the substance treatment may comprise an essential oil, including but not limited to lemon oil, orange oil, grapefruit oil, rosemary oil, sunflower oil, other fruit-derived oils, tea tree oil, cinnamon oil, eucalyptus oil and the like. According to embodiments, the substance may comprise a surfactant including but not limited to potassium oleate, sodium dodecyl sulfate (SDS) and the like. According to embodiments, the substance may comprise a humectant including but not limited to sorbitol, glycerin, glycerol and the like. According to embodiments, the substance may include buffering agents and/or mineral salts including but not limited to ascorbic acid, citric acid, sodium bicarbonate, calcium phosphate and the like. According to embodiments, the substance may include aroma and flavor compounds including but not limited to esters, linear terpenes, cyclic terpenes, alcohols, aldehydes, esters, ketones, lactones, thiols and the like.

It is foreseen that the aspects and features of the various embodiments described herein may be used in combination with each other.

While various exemplary embodiments have been described above, it should be understood that they have been presented by way of example only, and not limitation. Aspects of one embodiment can be used with other aspects of other embodiments of the invention in various combinations. Thus, the breadth and scope of the present disclosure should not be limited by any of the above-described exemplary embodiments.

1. A method for treating a perishable product comprising:
determining a desired product treatment outcome selected from sanitation, protection, preservation, or enhancement of the perishable product;
directly applying a substance to a surface of the perishable product after harvesting using a carrier; and
packaging the perishable product.

2. The method for treating a perishable product of claim 1, wherein the direct application of the substance to the surface of the perishable product occurs in an open atmosphere environment, wherein the open atmosphere environment is comprised of a room, chamber, tent, tunnel, tarped enclosure, or other partially contained environment with some capacity for the perishable products to enter and exit via an opening or unsealed entrance door or curtained opening or exit.

3. (canceled)

4. The method for treating a perishable product of claim 1, wherein the carrier is a liquid or a gas.

5. (canceled)

6. The method for treating a perishable product of claim 1, wherein the substance is applied (i) prior to cooling of the perishable product, (ii) after cooling of the perishable product, or (iii) during cooling of the perishable product in a cooling tunnel, cooling room, cooling chamber, or a ventilated space wherein the substance can be recirculated and directed across the surface of the product.

7-8. (canceled)

9. The method for treating a perishable product of claim 1, wherein the perishable product is treated inside of a film forming mechanism, wherein the film forming mechanism forms a package around the perishable product, and the treatment occurs just prior to or simultaneous to when the package is formed around the perishable product.

10. (canceled)

11. The method for treating a perishable product of claim 1, wherein the substance is applied (i) by an electrostatic spray configured to achieve directed spot or surface coverage or (ii) by a nebulizer configured to vaporize the substance and enable surface contact and coverage, adsorption, or infusion of the substance, wherein the nebulized substance is vaporized to achieve a predetermined concentration in the carrier.

12-14. (canceled)

15. The method for treating a perishable product according to claim 1 further comprising:
detecting a surface area of the perishable product; and
adjusting an amount of the substance to be applied based on the detected surface area of the perishable product.

16. The method for treating a perishable product according to claim 1 further comprising:
detecting a defect on the surface of the perishable product, and
applying the substance on the defect on the surface of the perishable product.

17. The method for treating a perishable product according to claim 1 further comprising:
detecting the amount of the surface of the perishable product that is covered by the substance, and
directly reapplying the substance to the surface of the perishable product when the amount of the substance on the surface of the perishable product does not meet a predetermined value.

18. (canceled)

19. The method for treating a perishable product of claim 1, wherein the substance is (i) selected from the group consisting of a sanitizer, an antifungal, an essential oil, a reducing agent, a surfactant, a humectant, a photosensitizer, a buffering agent, a mineral salt, an aroma, a sweetener or flavoring agent, a sealing or coating substance, an anti-browning substance, an ethylene scavenger, ethylene blocking compound, a ripening agent, a nutritional substance, a probiotic, a coloring, nano particles, phages, enzymes, and sugar substance or (ii) selected from the group consisting of chlorine dioxide, hydrogen peroxide, peracetic acid, ozone, ionized water, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, calcium phosphate, esters, linear terpenes, cyclic terpenes, alcohols, aldehydes, esters, ketones, lactones, thiols, rose oil, rose essence, air, and fruit essence.

20. (canceled)

21. The method for treating a perishable product of claim 1, wherein the substance wet or dry washes, prevents moisture loss of the perishable product, slows senescence of the perishable product, is a preservative, enhances color, enhances flavor, enhances aroma, enhances texture of the perishable product, or combinations thereof.

22-26. (canceled)

27. The method for treating a perishable product of claim 1, further comprising:
activating the substance on the surface of the product by applying a second substance, a light wave, or a sound wave, wherein the activation creates a new substance that sanitizes, enhances, preserves, or protects the perishable product.

28. (canceled)

29. The method for treating a perishable product of claim 1, further comprising:
measuring microbes present on the surface of the perishable product; and
applying an additional amount of the first substance to the surface of the perishable product when the amount of the microbes present on the surface of the perishable product is above a specified amount.

30. The method for treating a perishable product of claim 1, further comprising:
determining a defined dwell time of the substance based upon the purpose of the treatment and the characteristics of the substance; and
deactivating the substance when the defined dwell time of the substance has been reached.

31. The method of claim 1, further comprising:
wet or dry washing the perishable product with a second substance, wherein the wet or dry washing occurs (i) before the directly applying the substance, (iii) after the directly applying the substance, (iii) simultaneously with the directly applying the substance, (iv) after the packaging the perishable product, or combinations thereof.

32-64. (canceled)

65. A system for treating a perishable product with a substance treatment comprising:
one or more devices for directed substance application to a surface of the perishable products prior to final packaging of the perishable product using a carrier; and
wherein the one or more devices is an electrostatically charging device or a nebulizer.

66. The system for treating a perishable product of claim 65, wherein the directed substance application occurs in an open atmosphere environment, wherein the open atmosphere environment is comprised of a room, chamber, tent, tunnel, tarped enclosure, or other partially contained environment with some capacity for the perishable product to enter and exit via an opening or unsealed entrance door or curtained opening or exit.

67. (canceled)

68. The system for treating a perishable product of claim 65, wherein the carrier is a liquid or a gas.

69-73. (canceled)

74. The system for treating a perishable product of claim 65, further comprising a film forming mechanism, wherein the directed substance is applied inside of the film forming mechanism, wherein the film forming mechanism forms a package around the perishable product, and the treatment occurs just prior to or simultaneous to when the package is formed around the perishable product.

75. (canceled)

76. The system for treating a perishable product of claim 65, wherein the nebulizer is configured to vaporize the substance and enable surface contact and coverage, adsorption, or infusion of the substance, and to achieve a predetermined concentration in the carrier.

77-79. (canceled)

80. The system for treating a perishable product of claim 65, further comprising:
a sensor for detecting the amount of the surface of the perishable product that is covered by the directed substance.

81. The system for treating a perishable product of claim 65, wherein the directed substance is (i) selected from the group consisting of a sanitizer, an antifungal, an essential oil, a reducing agent, a surfactant, a humectant, a photosensitizer, a buffering agent, a mineral salt, an aroma, or a flavoring agent, a sealing or coating substance, an anti-browning substance, an ethylene scavenger, ethylene blocking compound, a ripening agent, nutritional substance, a probiotic, coloring, nano particles, phages, enzymes, and sugar substance or (ii) selected from the group consisting of chlorine dioxide, hydrogen peroxide, peracetic acid, ozone, ionized water, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, calcium phosphate, esters, linear terpenes, cyclic terpenes, alcohols, aldehydes, esters, ketones, lactones, thiols, rose oil, a rose essence, air, and fruit essence.

82. (canceled)

83. The system for treating a perishable product of claim 65, wherein the directed substance prevents moisture loss of the perishable product, slows senescence of the perishable product, is a preservative, enhances color, enhances flavor, enhances aroma, or enhances texture of the perishable product, or combinations thereof.

84-89. (canceled)

90. The system of claim 65, further comprising:
a sensor for evaluating the surface of the perishable product; and
a controller for controlling the directed substance application based on feedback from the sensor.

91-101. (canceled)

102. The system for treating a perishable product of claim 65, wherein a predetermined amount of the directed substance is applied to the surface to substantially coat or cover the surface.

103-144. (canceled)

145. The system of claim 65, further comprising a controller configured to:
determine a defined dwell time of the substance based upon the purpose of the treatment and the characteristics of the substance; and
deactivate the substance when the defined dwell time of the substance has been reached.

146. The method for treating a perishable product according to claim 1, further comprising:
applying a durable coating to the surface of the treated perishable product.

147. The method for treating a perishable product according to claim 146, wherein the durable coating inhibits microbial growth on the surface of the perishable product, inhibits moisture loss through the surface of the perishable product, controls moisture or gas transmission to the perishable product, or combinations thereof.

148-149. (canceled)

150. The method for treating a perishable product according to claim 1, wherein the substance breaks down biofilm on the surface of the perishable product or includes a surfactant.

151. (canceled)

152. The method for treating a perishable product according to claim 146, wherein the durable coating is applied immediately after the perishable product is treated with the substance.

153-182. (canceled)

183. The method for treating a perishable product of claim 146, wherein the durable coating is selected from the group consisting of cellulose, chitosan, alginate, potato starch, carboxymethylcellulose, aloe vera gel, calcium caseinate, whey protein, gelatin, soy protein, and butyl acetate.

184. A method for treating a perishable product with a substance comprising:
determining a desired product treatment outcome selected from sanitation, protection, preservation, or enhancement of the perishable product;
placing a perishable product in a tunnel, chamber, or a ventilated space; and
directly applying a substance to the surface of the perishable product using a directed gas carrier in the tunnel, chamber, or ventilated space.

185. The method for treating a perishable product of claim 184, wherein the directed gas is (i) cooled to cool the perishable product or (ii) forced across the surface of the perishable product.

186. (canceled)

187. The method for treating product according to claim 184, wherein the directed gas is from a pressurized gas gun, the directed gas acts as a carrier for the substance and allows for coating or penetrating the surface of the perishable product.

188. The method for treating a perishable product according to claim 184, wherein the perishable product is contained in a package inside of the tunnel, chamber, or ventilated space, the package has a vent(s) to allow the directed gas and the substance to contact the perishable product.

189. The method for treating a perishable product according to claim 188, wherein the directed gas carrier is recycled back into the tunnel, chamber, or ventilated space.

190. The method for treating a perishable product of claim 184, wherein the substance substantially covers the surface of the perishable product to achieve the desired treatment outcome.

191. The method for treating a perishable product of claim 184, wherein the substance is applied by an electrostatic spray.

192-195. (canceled)

196. The method for treating a perishable product of claim 184, wherein the substance prevents moisture loss of the perishable product, slows senescence of the perishable product, is a preservative, enhances color, enhances flavor, enhances aroma, enhances texture of the perishable product, or combinations thereof.

197-201. (canceled)

202. The method for treating a perishable product of claim 184, further comprising:
activating the substance by applying a second substance, or light wave, or a sound wave, wherein the activation creates a new substance that sanitizes, enhances, preserves, or protects the perishable product.

203. (canceled)

204. The method for treating a perishable product of claim 184, wherein at least one of the first and second substances are applied by directed application of ionized air.

205-255. (canceled)

256. The method according to claim 1, wherein the perishable product is treated after washing of the perishable product.

257-278. (canceled)

279. The method of claim 1, wherein the carrier is at least one of ionized water, acidified water, ethanol, isopropyl alcohol, nitrogen, or combinations thereof, or purified air.

280. (canceled)

281. The method of claim 1, wherein the perishable products are lettuce products, tomatoes, berries, cherries, meat products, fresh cut flowers, cannabis products, hemp products, or a protein including meat, fish, foul, and vegetable protein products.

282-308. (canceled)

309. The method for treating a perishable product according to claim 1, further comprising:
directly ionizing surface moisture on the perishable product, wherein the ionized surface moisture sanitizes the surface of the perishable product.

310-311. (canceled)

312. The system of claim 65, wherein the carrier is at least one of ionized water, acidified water, ethanol, isopropyl alcohol, nitrogen, or combinations thereof, or purified air, or purified air.

313. The system of claim 65, wherein the perishable products are lettuce products, tomatoes, berries, cherries, meat products, fresh cut flowers, cannabis products, hemp products, or a protein including meat, fish, foul, and vegetable protein products.
